(19) United States
(12) Patent Application Publication
(10) Pub. No.: US 2002/0059402 A1
(43) Pub. Date: May 16, 2002

(54) SERVER-SIDED INTERNET-BASED PLATFORM INDEPENDENT OPERATING SYSTEM AND APPLICATION SUITE

(76) Inventor: CHARLES E. BELANGER, BILLEVICA, MA (US)

Correspondence Address: FOLEY, HOAG & ELIOT, LLP, PATENT GROUP, ONE POST OFFICE SQUARE, BOSTON, MA, 02109, US

(21) Appl. No.: 09/134,396

(22) Filed: Aug. 14, 1998

Related U.S. Application Data
(60) Provisional application No. 60/030,994, filed on Nov. 15, 1996.
(60) Provisional application No. 60/030,996, filed on Nov. 15, 1996.
(60) Provisional application No. 60/038,411, filed on Feb. 18, 1997.
(60) Provisional application No. 60/055,782, filed on Aug. 15, 1997.
(60) Provisional application No. 60/057,256, filed on Aug. 29, 1997.
(60) Provisional application No. 60/060,612, filed on Oct. 1, 1997.
(60) Provisional application No. 60/065,416, filed on Nov. 13, 1997.

(51) Int. Cl. G06F 15/177

(52) U.S. Cl. 709/220

(57) ABSTRACT

The systems and methods described herein provide different types of Web authoring, Web site management, and communication software technology, including but not limited to full multimedia authoring, online libraries, sounds, forms, e-mail, facsimile, voice-mail, pager, telephone, financial management, true document printing (as opposed to screen printing), text-to-voice and voice-to-text conversion, file management, spreadsheets, all accessed and run via the Internet. The system resides entirely on an Internet Web Server site and interacts with users via conventional programming languages written for a universal protocol. As a result, there is no need for client-side messaging software. All software is provided on the server side. The only software the user needs is any form of communications module and an electronic communications connection. Because the system is platform and operating system independent, a user may author, create, maintain, send and receive messages from any platform, using any conventional operating system. A user may customize their desktop configuration and may run a variety of different applications. Moreover, a user may switch between applications, and transfer text, graphics, or sound files between applications.

### BACKGROUND OF THE INVENTION

The evolution of the computer industry has been from mainframes, where all users have to take turns running software programs on a central computer system from “dumb” terminals on their desks, to smart and powerful desktop personal computers (PCs) in which users run software either from a removable disk or a hard drive.

As users have demanded numerous enhanced features for the software programs, it has become increasingly complex and difficult to install, maintain and run programs from local storage. For example, a typical word processing program fills several disks, even in a compressed format. This large size, combined with distribution challenges and costs, may make it impractical and not cost-effective to upgrade the programs on a frequent basis. Also, the programs have to be installed and configured by each user on their own PC, which can be challenging and time consuming. An additional disadvantage of PCs is that they are not very mobile, and powerful mobile laptops are very expensive.

Networks of PCs, typically in an office setting, have allowed key programs to be run from a central server without requiring users to take turns using the software. However, if a user wishes to be able to run several different programs simultaneously, and to switch between the programs at will, the user must have a powerful operating system installed on the PC, such as the MICROSOFT WINDOWS operating system, which takes up a significant amount of storage space on the hard drive. Also, in some conventional systems, each application must share a common operating system, limiting the types of applications available to the user of such operating systems.

One of the most significant developments in the computer industry has been the growth of the Internet and the World Wide Web. Computer users view Web sites, create and manage Web sites, and review and send electronic mail messages. All of these functions require software installed on the user's PC. The PC ties the user to a particular location. Moreover, such functions cannot be provided by many less-powerful computing devices or non-computing appliances. Less powerful devices do not have adequate local storage to permit the user to install powerful programs, such as web authoring programs.

None of the software on the application programs on the market today, such as WORDPERFECT, MICROSOFT WORD, etc. can run on network computer (“NC”) appliances. Yet all of these NC appliances may be configured to allow a user to access the Internet. The problem is severe limitations on what they can do once connected to the Internet.

### SUMMARY OF THE INVENTION

The present invention may be better understood by reference to a number of commonly used terms, definitions of which are as follows:

The term “client,” as used herein, encompasses any data processing systems suitable for establishing a communication link to a communications network, such as an Internet site. An Internet site can be any program running on a data processing platform that connects to the Internet and that receives access requests, whether under HTTP, FTP or any other conventional or proprietary transfer protocol.

The term “application program,” as used herein, encompasses any computer file that contains data in a format for being accessed and processed by the processing unit of a computer.

The term “disk,” as used herein, encompasses any storage device that can store computer data and that provides an interface for accessing the stored data.

The term “network,” as used herein, encompasses any system comprising a series of computers linked by communications capability and may include the Internet, intranets, telephone networks, wireless and satellite communication networks, or other communications or computer networks.

The term “Internet” means the largest global computer communications network.

The term “World Wide Web” means a large global computer communications network that comprises a significant part of the Internet.

The term “server,” as used herein, encompasses any data processing system on which application programs and Internet sites may be stored for access and processing by client computers and encompasses either hardware or software, or a combination thereof, for accomplishing such function.

The term “web browser,” as used herein, encompasses any application program which allows for a link to an Internet site and may include programs that provide for multimedia presentation of information, including text images, sound and video clips.

The term “hypertext link” as used herein, encompasses any graphical icon, button, highlighted text or other symbol that permits a client computer to direct a server to display a page of an Internet site which is associated with the hypertext link.

The term “URL” means “uniform resource locator” and means the address of an Internet site that is accessed by clicking or initiating a hypertext link that is associated with the URL.

The term “HTML” means hypertext markup language, which refers to a language for the creation of pages of Internet sites on the World Wide Web according to the Structured Generalized Markup Language standard.

The term “HTTP” as used herein, shall encompass the “HyperText Transfer Protocol”, a protocol under which messages are sent over the Internet from client computers to server computers in the client-server model of distributed computing.

The term “CGI” shall mean “Common Gateway Interface,” which shall refer to a specification for communication between a server computer and an application program. Versions of CGI include fast CGI, which permits communication between a server computer and more than one application program running simultaneously.

The term “EDI”, or “electronic data interchange” shall mean a protocol for the transfer of data between an application program and a proprietary computer system.

The computer operating systems disclosed herein include a computer operating system that allows a communications device-enabled user to run a plurality of computer applications, independent of the non-communications characteristics of the communications device.

A computer operating system for remote users and methods for providing such a system are provided herein. The operating system may include a user device capable of sending and receiving signals via a communications network, a first server computer having storage, wherein the first server computer includes a processing mechanism for sending and receiving signals via the communications network in selected formats from a set of available communications formats, and a device recognition module of the first server computer for determining the communications format for the user device based on characteristics of the signal from the user device. An application program of the first server may run in response to signals received from the user device according to the selected communications protocol, so that signals from the application program of the first server may be sent by the server signal mechanism to the user device according to the selected communications format. Thus, a remote user may run an application program that resides entirely on a server computer, without the need for local data

storage. The absence of a need for local data storage means that a given user can access the operating system from any user device at any location, not just the user's own user device.

The server may include a dedicated location in memory for storing files and other information associated with each user of the operating system. These files may be used to create a unique “desktop” environment for each user, and to store data associated with the user of the same type as a local hard drive or disk would store if the user were using a personal computer. Thus, the dedicated storage creates a virtual hard drive location in memory for the user, the memory being located on the server, rather than on the user's device.

The operating system may further provide a connection to additional servers connected to a network, including the Internet. The operating system may communicate with applications running on these additional servers according to well-known protocols such as HTTP, so that application programs running on the other servers may be accessed and run by the first server, with the results of the applications being sent to the user device and/or stored in the dedicated memory of the server computer for later access by the user. Through use of conventional Internet programming techniques, such as PERL code enabled with fast CGI, application programs running on the first server and on the additional servers may be made to operate independently and to interact, so that applications may send, receive and share data among each other from different locations.

The user may also run multiple applications at one time.

The operating system may provide an access control mechanism of the server computer for restricting access to a file stored in the storage that is associated with the user of the user device.

The operating system may be used with any user device that is communications-enabled. Thus the devices may include mainframe computers, desktop personal computers, laptop personal computers, network computers, Internet telephones, pagers, cellular phones, mobile phones, satellite phones, hand-held personal information managers, non-computer appliances, network computers, cable television boxes, web televisions, television sets, and set-top boxes. Communications may be by wireless transmissions, satellite transmissions, fiber optic networks, or other means of transmitting data to the server computer.

Any computing application can be made available under the operating system through the first server or additional servers. Examples include a web authoring application, an electronic mail application, a database application, a search application, a chat application, a graphics application, a personal information manager applications, a scheduler application, a calendar application, a word processing application, a spreadsheet application, a calculator application, a document management application, a drawing application, a presentation application, a translation application, a speech recognition application, and a data formatting application.

The systems and methods described herein provide an operating system that resides solely on the server-side and that permits all computing applications to be accomplished by any device that is capable of a network connection, without the need for local storage for applications. Such applications include Web authoring, Web site management, and communication software technology, including but not limited to full multimedia authoring, online libraries, sounds, forms, e-mail, facsimile, voice-mail, pager, telephone, financial management, true document printing (as opposed to screen printing), text-to-voice and voice-to-text conversion, file management, spreadsheets, all accessed and run via the Internet. The system resides entirely on an Internet Web Server site and interacts with users via conventional communication protocols. As a result, there is no need for client-side messaging software. All software is provided on the server side.

The only software the user needs is any form of Web browser and an electronic communications connection. The system is platform and user device independent. A user may author, create, maintain, send and receive messages from any platform or user device. A user may customize their desktop configuration to run any computing application. For example, a user may switch between applications, transfer text, graphics, or sound files between applications.

In embodiments of the invention, a server computer includes a processing mechanism for receiving signals representing a home page (also known as a Web site or a Web page) from a communications network, converting the signals into a data file, and storing the data file in the memory, a user device adapted for transmitting and receiving signals from the communications network, a communications connection between the server computer and the user device, an access control mechanism connected to the server computer for determining access rights to the data file stored in the memory of the server computer, and a server signal mechanism connected to the server computer and responsive to the access control mechanism, for receiving signals from the user device and for sending signals to the user device, via the communications connection, for generating markup language page signals representative of the data file, wherein the processing mechanism, the access control mechanism, and the server signal mechanism permit a user of the user device to view, edit, delete, reproduce, or retransmit, or some combination or variation thereof, certain of the data files via interaction with the markup language page signals.

The user device may be selected from the following group of devices, for example: mainframe computers, desktop personal computers, such as, for example, IBM, IBM-compatibles, and MACINTOSH, laptop personal computers, network computers, Internet telephones, pagers, mobile phones, hand-held personal information managers, non-computer (NC) appliances, cable television boxes, television sets, and set-top boxes, or some combination or variation thereof. The user device preferably should include a full or a partial Web browser program, such as, for example, NETSCAPE NAVIGATOR or NETSCAPE COMMUNICATOR, MICROSOFT EXPLORER, MOSIAC, or some combination or variation thereof.

The communications network may be the Internet, may be the World Wide Web, may allow communication via wireless transmissions, or may allow communication via transmissions through fiber optic lines, or some combination or variation thereof, such as, for example, electronic transmissions or radio-wave transmissions. The communications connection may be the Internet or the World Wide Web. The communications connection may allow communication via wireless transmissions, through fiber optic lines, through electronic transmissions, or through some combination or variation thereof. The remote home page authoring system may include a registration mechanism connected to the server computer for storing, accessing, and, optionally, modifying a list of names of registered users, which could include, for example, individuals, corporations, families, members of particular communities, or shared-interest groups.

The access control mechanism may allow a registered user to create their home page, and to modify, save, reproduce and delete at least a portion of their home page. The access control mechanism may allow a registered user to add text, sound, color, and moving images, or some combination or variation thereof, to their home page. The access control mechanism may allow one or more third parties to view the home pages of one or more registered users, via the communications network, even if the third parties are not themselves registered users.

A method of home page management according to the systems and methods described herein may include providing a server computer for receiving signals representing a home page from a communications network, converting the signals into a data file, and storing the data file, providing a user device for transmitting and receiving signals from the communications network, connecting the server computer and the user device via a communications connection, receiving signals from the user device, sending signals from the server computer to the user device for generating markup language page signals representative of the data file, and determining access rights to the data file, thereby allowing a user of the user device to view the data file via interaction with the markup language page signals if the user is allowed access rights to the data file.

A method of remote home page authoring may further include providing a registration process for allowing users to request registration on the system and for storing a list of registered users, and, optionally, allowing a registered user of the user device to create their home page and to modify, save, reproduce, or delete, or some combination or variation thereof, at least a portion of their home page. A method of remote home page authoring may further include allowing a registered user of the user device to add text, sound, color, graphics, and moving images, or some combination or variation thereof, to their home page.

### BRIEF DESCRIPTION OF DRAWINGS

FIG. 1 is a schematic diagram illustrating an embodiment of a server-sided Internet based operating system according to the systems and methods described herein.

FIG. 2 is a schematic diagram illustrating the user device that is connected to the system disclosed in FIG. 1.

FIG. 3 is a schematic diagram illustrating the server that part of the system depicted in FIG. 1.

FIG. 4 is a flow chart illustrating steps accomplished by the operating system disclosed in FIG. 1.

FIG. 5 is a schematic diagram further illustrating the functional relationship of components of the system disclosed in FIG. 1.

FIG. 6 shows a block outline of the INERGY 2000 operating system. The outline shows the features that may be included in the basic package, as well as add-on functionality that may be added.

FIG. 7 is a schematic illustration of one application that can be accomplished by the operating system of FIG. 1, namely, a web authoring program, and shows that this application may also be connected to the File Manager, the WEBWRITER, and the spell checker, for example.

FIG. 8 is a schematic diagram that illustrates another application that may be run under the operating system of the present invention, namely, a word processing program, and includes examples of some of the editing features that may be available, as well as optional connections to other applications, such as to electronic mail, and to tools such as a file manager and a file format conversion application. Printing, faxing, and connections to other servers also are shown.

FIGS. 9 through 16 show screen shots of screens that are viewed by the user's browser in an embodiment of the invention, including login, folder management, file management, and editing functions.

FIGS. 17 through 60 show examples of Web screen shots and the corresponding source code for such screens, according to embodiments of the systems and methods described herein.

FIGS. 61 through 79 show examples of Web screen shots according to embodiments of the systems and methods described herein. The screen shots reflect functions accomplished by the operating systems of the present invention.

FIGS. 80 through 95 depict source code for embodiments of an operating system of the present invention.

### DETAILED DESCRIPTION OF THE PREFERRED EMBODIMENTS

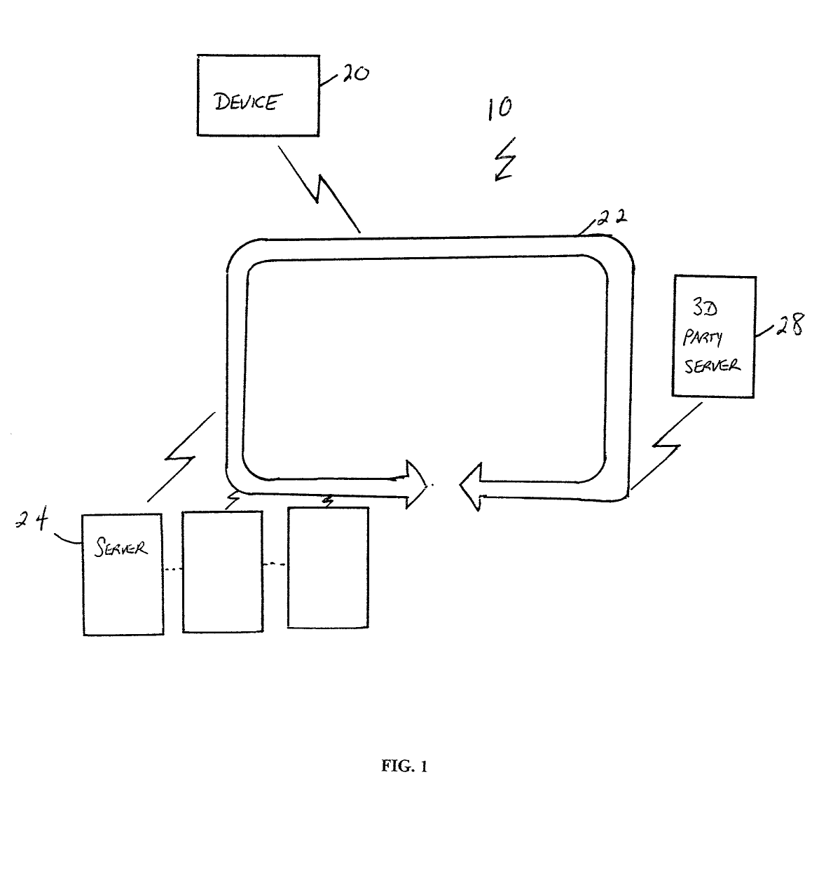

Referring to FIG. 1, the components for an operating system of the present invention are illustrated in a schematic diagram. A user device 20 is connected to a communications network 22. The user device 20 may be any communications-enabled device. In an embodiment of the invention, the user device is a laptop or personal computer with an Internet browser. The only requirement for the user device is that it include communications-enabling capability and some form of user interface. In an embodiment, the user interface is a graphical interface, such as a computer screen or television screen, with an input device such as a keyboard and mouse. The user device 20 does not require any specific software or storage capabilities for running local software applications, other than the minimal amount of software and storage necessary to execute a communications function and to control the user interface. There is no need for client-side messaging software at the user device 20. The user only needs to be communications-enabled, whether by software, by phone, or by other means. To take full advantage of the systems and methods disclosed herein, the user may have a Web browser, such as NETSCAPE NAVIGATOR, NETSCAPE COMMUNICATOR, MICROSOFT EXPLORER, NETCOM, MOSAIC, or any other partial browser, and an Internet, intra-net bulletin board, or other electronic communications connection or a noncomputer communications connection such as one designed for use in connection with a television set, for example WEBTV.

The user device 20 is connected to a communications network 22. The network may be the Internet, the WorldWide Web, or any other communications network, including a fiber optic network, a wireless network, a conventional telephone network, a satellite communications network, or the like. In an embodiment of the invention, the network is a global communications network, such as the Internet. Also connected to the communications network 22 is a server 24. It should be understood that the server 24 could comprise a group of linked servers that accomplish the functions described with respect to the server 24 herein; that is, references to “server” should be understood to include multiple servers, or any other computing device that is capable of performing the functions described herein in connection with the server 24. The server 24 may consist of hardware or server software running on a conventional computer. In an embodiment of the invention, the server is an HTTP server that is enabled for communicating over the Internet in the HTTP communications protocol. The server 24 may be connected to the communications network 22 by any conventional mechanism, such as a network interface card, a modem or a telephone line.

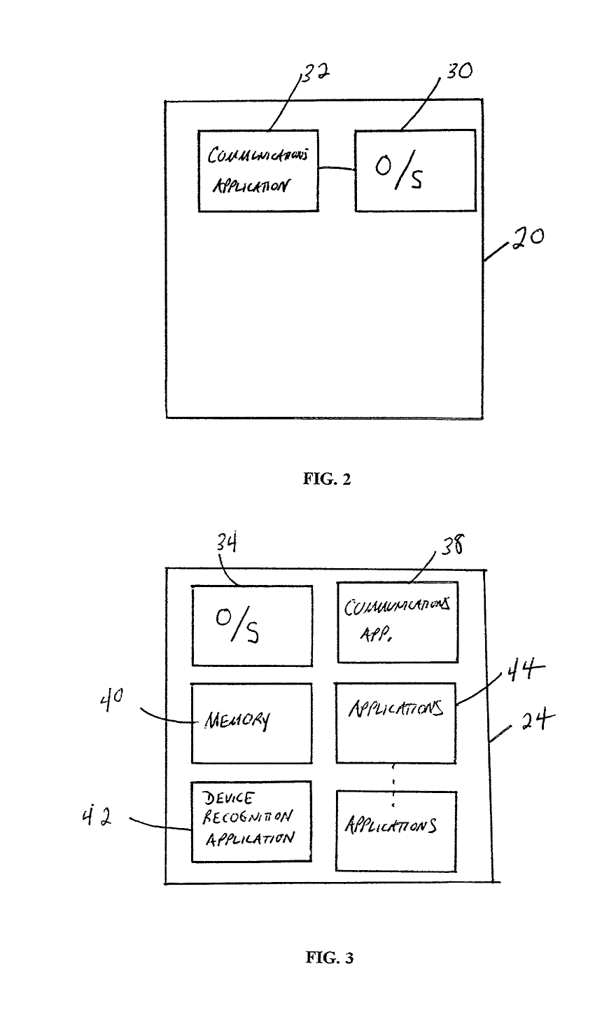

Referring to FIG. 2, the user device 20 is illustrated in schematic format, including an operating system 30 and a communications application 32 operated by the operating system. It should understood that the operating system 30 may be a minimal amount of programming code necessary to enable communications operation and a sufficient user interface to permit the user to interact with the communications operation. It should be noted that the communications application 32 is the only application necessary for running on the device 20. That is, there are neither memory management nor other applications running on the device 20. It should be understood that the device could include such applications, but such applications are not necessary to accomplish the operating systems disclosed herein. That is, the operating systems disclosed herein operate exclusively on the server side in the conventional client-server model.

Referring to FIG. 3, the server 24 is displayed in a schematic diagram in further detail. An operating system 34 of the server 24 may be a conventional operating system suitable for Internet applications, such as a UNIX operating system. The operating system 34 is coupled with additional code as disclosed herein to provide an extended, server-side operating system. The operating system 34 should be capable of operating a graphical user interface, managing storage, and operating other communications applications, as well providing database management and other data processing, storage and retrieval applications. The operating system controls applications installed on the server 24, including a communications module 38, a device recognition module 42 and other applications 44 that reside in memory 40 of the server 24. The memory 40 may be any conventional storage typical of that included on a server, particularly a server suitable for Internet operations. In an embodiment of the invention, the operating system 34 is a UNIX operating system that is programmed with an Internet programming language, such as PERL. Different applications may be executed simultaneously through use of known Internet programming techniques, such as use of fast CGI scripts, which may be an extension of PERL code. In this embodiment, the UNIX operating system 34 runs the other applications 44 at all times in a loop. Data from the user device 20, when inputted by the user, is then formatted in the form of a CGI script form that is submitted to the server 24. When the form is submitted, it is recognized by the appropriate programming as calling for processing, which results in the opening of a communications channel, or socket, that calls for processing by the appropriate application 44. Use of PERL code with fast CGI scripts is a well-known technique for permitting multiple applications to be run simultaneously and to be accessed from a local server or a remote server.

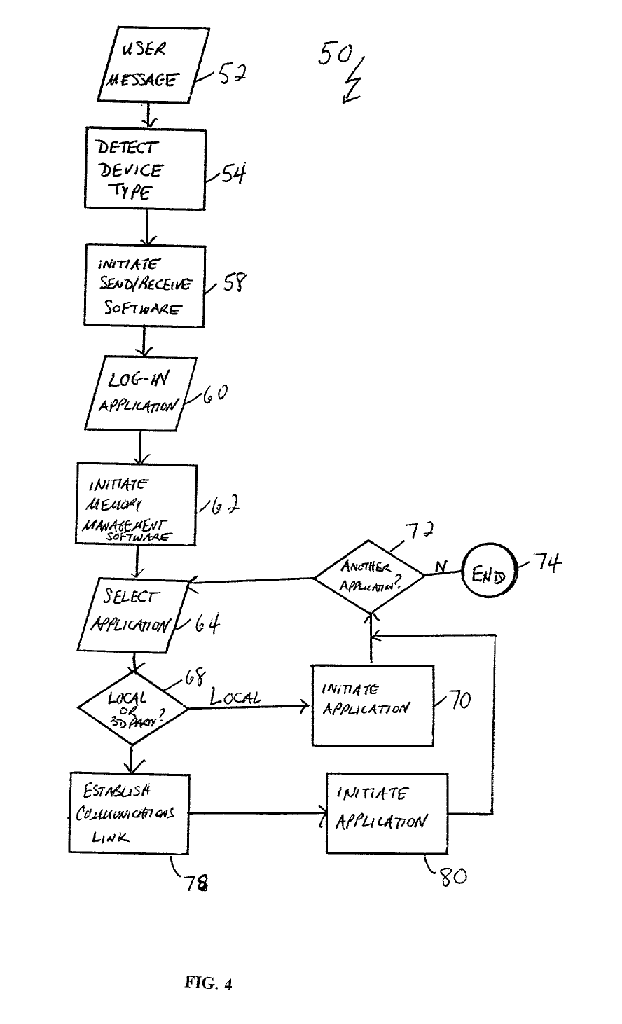

Referring to FIG. 4, a flowchart 50 is provided in which steps accomplished by the operating systems of the present invention are illustrated. In a first step 52, a user message is sent by the user device 20 via the network 22 to the server 24. The user message may be any form of signal that is generated by a communications device. In an embodiment of the invention, the user device is a browser, and the user message is an HTTP message; however, the message could be a signal from a cellular phone, a noncomputer appliance, a personal information manager, or other device. The signal is not required to be in any particular format, just some type of known format, such as HTTP, fax, phone, or the like; that is, no hardware or software is required in the user device 20 in order to format the signal according to any particular protocol. Thus, any user device 20 that can send a signal can be used in connection with the operating systems disclosed herein. Because the system is platform and operating system independent, a user may author, create, maintain, send and receive messages from any platform, including but not limited to IBM PC and compatible platforms, MACINTOSH platforms, and noncompute r (NC) or set-top boxes such as WEBTV, using any operating system, including but not limited to MICROSOFT WINDOWS, WINDOWS 95, WINDOWS NT, WINDOWS CE, DOS, UNIX and proprietary or legacy operating systems.

At a step 54, in response to any incoming signal, the operating system 34 of the server 24 initiates the device recognition module 42. The device recognition module provides a function that may be written in an conventional programming language, such as PERL. The device recognition module 42 executes a matching algorithm that compares the characteristics of the signal to a set of known signal characteristics. In some cases, recognition may be accomplished in part by recognizing the input channel of the signal; thus, a signal coming in over a telephone line may be recognized as either a voice signal, a telephone keypad signal, or a modem signal by virtue of the fact that it is sent over a telephone line. Similarly, if the signal comes through the network interface card of the server 24, then the device is recognized as being a device capable of sending HTTP protocol data, such as a browser. Known user devices have characteristics that are unique and identifiable when a signal from the user device 20 is sent over the communications network 22 to the server 34. A truth table can be generated that associates each type of known user device, such as each browser, with the signal characteristics and the capabilities of that browser. The table may created by a standard matching algorithm written in a conventional language such as PERL. In the case of many browsers, the signal includes the device name and type in the message codes. The signal characteristics are matched against a known library of such signal characteristics, or simply the device name, permitting the device recognition module 44 to identify the nature of the user device 20. Identification of the user device 20 is thus accomplished without need for special user input, avoiding the need for software at the user device 20 that formats signals according to a particular protocol or that identifies the user device 20 as being of a certain type.

Next, at a step 58, the operating system 34 of the server 24 may initiate the communications module 38. The communications module 38 has a number of features that accomplish the sending and receiving of data. First, the communications module 38 is capable of receiving data in any of a wide variety of known formats and converting the data to an appropriate format for storage, manipulation, and retrieval. The communications module 38 processes data in the format that is appropriate for the user device 20 that was identified by the device recognition module 42 at the step 54. For example, if the user device 20 is identified as an Internet browser, the communications module 38 recognizes that data should be processed in HTTP format. If the user device is identified as a telephone, then the communications module 38 may initiate voice recognition code that converts voice signals from the user device 20 into text, which can then be used for further processing. It should be understood that the communications module 38 may consist of a suite of different applications that are running on the server 24. Some of the applications that comprise the communications module 38 may reside on the third party server 28. The operating system 34 controls the communications module 38, which initiates all of the functions necessary to receive and properly format signals for further processing. Applications or code that accomplish reformatting of data signals are well-known. Such applications include voice recognition software, such as Dragon Systems' Naturally Speaking software, which converts from voice to text and from text to voice, as well as software that converts files between different text and word-processing formats, between text and graphics formats, and the like. The communications module 38 preferably includes a suite of applications that can convert data between any two desired formats.

In addition to receiving signals and converting them into the proper format for processing, the communications module 38 permits the server 24 to format a signal to be sent over the communications network 22 to the user device 20. The format of the signal 22 is determined by the communications software 38, based upon the type of user device 20 detected at the step 54. Thus, if the device is a personal computer with a browser, then the communications software 38 may send a signal that is according to the Internet HTTP protocol. Based on the characteristics of the particular user device 20, such as a particular browser, the signal may be formatted to conform to the characteristics of that browser, which are identified in the truth table that is included in the device recognition module 42. If the device is a phone, the communications module 38 may send a voice signal, which has been generated by voice generation software code. The content of the signal sent to the user device 20 will be based on the processing selected by the user. The user sends signals via the user device 20, the signals are processed by the communications software 38, and the signals are then relayed in proper format for further processing as described below. As processing of signals is completed, the results are sent back to the user device 20 in the proper format, so that the user can obtain the results of computer processing. Thus, the communications software 38 permits the user to interact with the server 24 in a variety of data processing formats, from any user device in any location, without the need for special software for communicating with the server 24.

Once a communications link has been established at the step 58 between the server 24 and user device 20, thus formatting any incoming signal in an appropriate format for further processing, the user may interact with the other software applications 44 running on the server 24. In an embodiment, as depicted in the flowchart 50 at a step 60, a first application is a log-in application. The log-in application may be a conventional log-in application, such as a table with entries to be completed by the user.

New users may be prompted to enter information that will be stored in the memory 40 of the server 24. In order to receive an account on the system, a user may be required to register, e.g., through their television, mail, telephone, facsimile, or on-line. Existing users may be prompted to enter a password, which will be compared to the password for the user stored in the memory 40. The log-in application may be any conventional type of log-in application, and may be written in a conventional, Internet-based language, such as Java.

In an embodiment in which the user device is a browser, when a previously-registered user logs in to the operating system 10, the user's login ID and password are sent, using HTTP, to the server 24, which may be located anywhere, and then passed, using CGI script code, to the operating system 10, which then accesses the user's profile from the database of user profiles, using conventional database software, such as Berkeley database software. Based on the data in the user's customer profile, a set of scripts are run, which then are sent back to the Web server, which passes the HTML instructions to the user's browser, using HTTP, and the user's browser then displays the user's customized desktop configuration, as discussed below.

Once the user logged in, at a step 62 the operating system 34 of the server 24 may call memory management software that is running on the system for controlling the data storage memory 40 of the server 24. The memory management software may then store information obtained at the log-in step 60 in a location in the memory 62. The memory management software may be used to partition a location in memory that is dedicated to the particular user. The partitioned location is thus a “virtual” hard drive, mimicking the functions of a conventional disk, hard drive, or other storage device that would normally reside on a personal computer on the client side, i.e., on the user device 20. The presence of the virtual hard drive in the memory 40 avoids the need for storage at the user device 20. The memory management software runs throughout the operation of operating systems disclosed herein, so that operation of any applications 44 results in storage, retrieval, and manipulation of information in storage in a conventional manner similar to that which is performed by other memory management applications for conventional client personal computers. In an embodiment of the invention, memory management software consists in part of Berkeley database software.

The memory 40 may include files associated with the particular user. Referring to FIG. 5, a schematic diagram illustrates a method of implementation of a server-sided Internet based operating system according to the present invention. Once on the web site at the log-in step 60 of FIG. 4, a new user may register for access to one or more of the applications 44 on the operating system's suite of desktop applications 44, including such programs as a word processor, e-mail, chat, web-authoring software, a contact manager, a personal information manager (“PIM”), spreadsheet software, voice-to-text & text-to-voice software, financial management software (including electronic checkbook and bill payment), personal and corporate bookkeeping, data management, desktop publishing, desktop (or WEBTOP) administration, meeting manager/scheduler, etc., all of which may reside on the server 24. These applications 44 may be written in any programming language, such as JAVA, PERL, CGI scripts, C, C++, LISP, or the like. In an embodiment, an Internet programming language, such as JAVA or HTML is used. These applications 44 may also be conventional off-the-shelf applications that are acquired from third parties and installed on the server 24 or a third party server 28, programmed by conventional means. These applications may be interlaced with online creative multimedia tools. At the log-in step 60, the new user may then be given a password, which they may modify, and is given a standard desktop configuration of the applications, including a standard background.

Referring to FIG. 5, a database, which may reside on the server 24 (which may be a server farm or on some other server), may be maintained that includes a customer profile for each customer. The customer profile, which may include one or more customized desktop configurations, may be updated by the user either consciously, through selection of an option such as “SETUP”, or may be automatically updated as the user rearranges or otherwise modifies their desktop while they are actively connected to the operating system. Each user may customize their desktop arrangement. For example, users may upload graphics, text, or sounds to use as a background. Users may add and remove hypertext links to their favorite Web sites. Users may modify the size, shape or arrangement of the icons or symbols that permit access to each of the applications, etc. A user may have one customized desktop configuration for use in the office and another customized desktop configuration for use at home. In addition, a family may have a common desktop configuration (or set of configurations), but different passwords for e-mail for each of the family members, so that each of the family members can have private e-mail. In other words, the files stored in the memory 40 of the server 24 dedicated to the user may include a file associated with the selected configuration of the interface that the user desires. Thus, upon logging in at the step 60 and initiating the memory management software 62, the system 10 may, at a step 64, display the “desktop” for the user that permits the user to select an application.

The user may customize the desktop by interacting with an application that permits the user to select applications that the user wishes to make available. It should be understood that different “desktops”, or initial files, may be stored for each user, corresponding to different input devices. For example, if the user device 20 is recognized to be a hand-held computer without a keyboard, then a “desktop” file may be created that includes a keyboard that can be used by pointing and clicking with a mouse. If the user device is recognized to be a voice telephone, the “desktop” may consist of a series of voice signals that invite the user to select a particular command from a menu of commands. For example, the voice command could state: “to send or hear e-mail, say ‘e-mail’.” Thus, a file customized to the user creates a unique desk top appearance (or sound) that is sent by the communications module 38 to the user device 20 over the communications network 22. In an embodiment, the user device is a personal computer, and the graphical user interface displays a page, such as an HTML page, that depicts icons as graphical objects that can be clicked by the user using a mouse or cursor to select a particular application. In a different embodiment, if the user device 20 is a cellular phone and the signal is a keypad tone from the phone, then the user “desktop” file for a cellular phone may be loaded, so that the user may select an application by pressing a number on the keypad of the phone.

In an embodiment, once the “desktop” file is displayed, the user can then access any of the applications for which they have registered, which may include one or more of the applications shown in the “desktop” layer of the diagram in FIG. 5. Each of the desktop applications also may have access to one or more of the tools in the “TOOLS” layer of the diagram in FIG. 5. For example, a user may receive an e-mail message with an attached document in MICROSOFT WORD format. The user may wish to edit the document using the WEBWRITER program. The File Manager tool will allow the user to convert the MICROSOFT WORD document into Text format, which the WEBWRITER can read. The user can then edit the document and user File Manager to convert the revised document back to MICROSOFT WORD format and send it back as an attachment to an e-mail reply message. Or, the user could convert the document for use in the spreadsheet or bookkeeping application. The user also may even add the document to their personal or business Web site. A variety of additional options will be apparent. For example, the spell-check tool may be accessed from the word processing program, as well as from the e-mail program or the Web site creation and management program, etc.

The “desktop” file preferably includes a menu from which the user may select other applications. It may also include news feeds, bookmarks, advertising, and other features. That is, the desktop file should be understood to be similar to the main menu that appears after logging on to a personal computer. Using icons, text, voice, or other prompts, the desktop makes available for the user other applications 44. The user may thus select a particular application through the input of the user device 20. The other applications 44 may be any computing applications. The user may add or delete applications from the menu that appears on the “desktop” file by interacting with the file in a conventional manner. For example, a pull-down menu may exist at the top of the screen that permits the user to “add” or “delete” an item that has been high-lighted by clicking a mouse.

Referring to the flowchart 50 of FIG. 4, at a step 64 the user selects an application. Having selected an application, the operating system determines whether the application is stored locally or on a third party server 28 at a step 68. A local application is an application running on the server 24. If the local application is selected, then the operating system 34 of the server 24, which is running all of the applications 44 in a loop, will result in the appropriate application recognizing a form sent by CGI script that is recognized by the application as calling for processing. Having recognized the form, the application initiates processing in a step 70 and runs the application. Signals based on the application may be sent by the server 24 over the network 22 to the device 20. Thus, at the user device 20, pages are displayed, voice signals are heard, or other signals are processed based on the results of the application. If the application is an application that produces output in a particular format, such as text, then the communications module 38 re-formats the output into a format appropriate for the user device 20. Thus, if the user device is a phone, and the output of the application is text, then the communications module 38 initiates voice-generation software (which may reside on the server 24 or on a third party server 28) that converts the text to voice and plays the voice message to the phone. Thus, a user can use any application 44 as if the user were using an application located in storage of the user device 20, even though that device may have only sufficient storage to enable communications and a user interface.

Upon completion of the application selected at the step 64, or at any other time, the user may initiate another application at a step 72. If the user wishes to run another application, then the user is returned to a menu at the step 64. If at the step 72 the user does not wish to execute another application, then the user may end the program at a step 74 by any conventional means, including turning off the device or logging out.

If at the step 68 the application is a third party application, rather than a local application, then the server 24 initiates the software that establishes a communications link at a step 78 to another server. The other server may be the third party server 28 depicted in FIG. 1. The communications link may be established by the communications module 38. Thus, the third party device could be a server or other computing device that is capable of communicating over a communications network, such as the communications network 22. Once the communications link is established, the server 24 may send signals to the third party server 28 which is running other applications 44 in a loop, under an operating system such as a UNIX system. Signals may be sent using PERL code with fast CGI script capability. The user signal is formatted to initiate the application, such as a CGI script form, which results in recognition by the selected application 44 running on the third party server 28. While the application is running, the server 24 receives signals reflecting the processing of the third party 28 and relays those signals over the communications network 22 to the user device 20 in the proper format, as described above. Once the application is complete, or during running of an application, the user may at a step 72 execute another application, at which point the user may select an application at menu at the step 64. Alternatively, if processing is complete, then the user may end at the step 74 in a conventional manner. Switching between running applications can be accomplished by the operating system in a conventional Internet programming manner, such as through use of PERL code enabled with fast CGI scripts.

Thus, embodiments of the invention permit the user to accomplish any computing function through use of an operating system that does not require the user device 20 to have storage or to have installed software applications, other than minimal amounts required to enable communications. Thus, embodiments include web authoring software, contact management software, search and retrieve software, translation software, image retrieval and manipulation software, electronic mail software, and data manipulation and formatting software. These software applications may be made compatible with each other so that data can be transferred among them to create a suite of interconnected software applications, all running under an operating system residing solely on the server 24, or on a third party server 28 that is accessible over the communications network 22 by the server 24. Thus, the system 10 appears and acts in all respects to the user like an operating system installed in the storage of a personal computer, and it accomplishes all computing functions normally accomplished by a mainframe or personal computer. However, the user is not required to use a particular user device, and the user device is not required to have more than minimal hardware or storage. Moreover, the same user may use different devices at different locations to accomplish computing functions, since all of the user's files are stored in virtual memory at the server 24. Certain embodiments and applications of the operating systems disclosed herein are further disclosed below.

Applications that can be accomplished by the systems and methods described herein include Web authoring, Web site management, communications, full multimedia authoring, online libraries, sounds, forms, e-mail, chat, facsimile, voice-mail, pager, telephone, financial management, true document printing (as opposed to screen printing), text-to-voice and voice-to-text conversion, file management, and spreadsheets, all accessed and run via the Internet. A user may also create, receive, edit, and print documents (in which case the user would require a local printer attached to the user device 20, or would be required to wait for a document to be printed by a printer attached to the server 24 and otherwise transmitted to the user), run financial packages, pay bills electronically, convert text-to-voice and voice-to-text, manage personal information, schedule appointments, run desktop publishing software, send and receive facsimile messages, etc.

In an embodiment of the invention, the system resides entirely on an Internet Web Server site and interacts with users via standard hyper-text markup language (“HTML”), which is described in Ian S. Graham, HTML Sourcebook, 3d ed. (1997), PERL, CGI, and JAVASCRIPT programs, which are written for a universal protocol, currently HTML Standards Version 3.0. The system also includes code written in UNIX, PERL, JAVA, and C++. General techniques of Internet programming are described in Kris Jamsa, Ph.D. and Ken Cope, Internet Programming (1995). Data storage, manipulation and retrieval functions may be accomplished by conventional database programs, such as Berkeley, Oracle, or similar programs.

FIG. 6 shows a block outline of the INERGY 2000 operating system. The outline shows the features that may be included in the basic package, as well as add-on functionality that may be added.

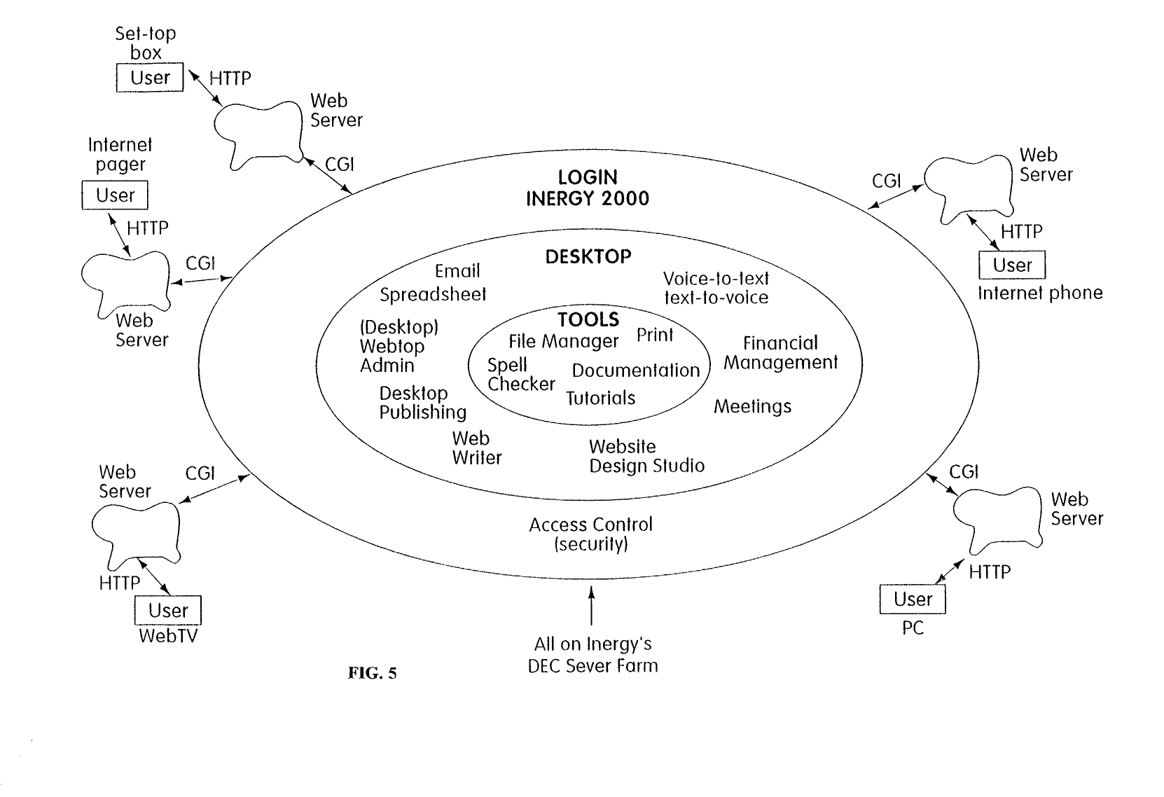

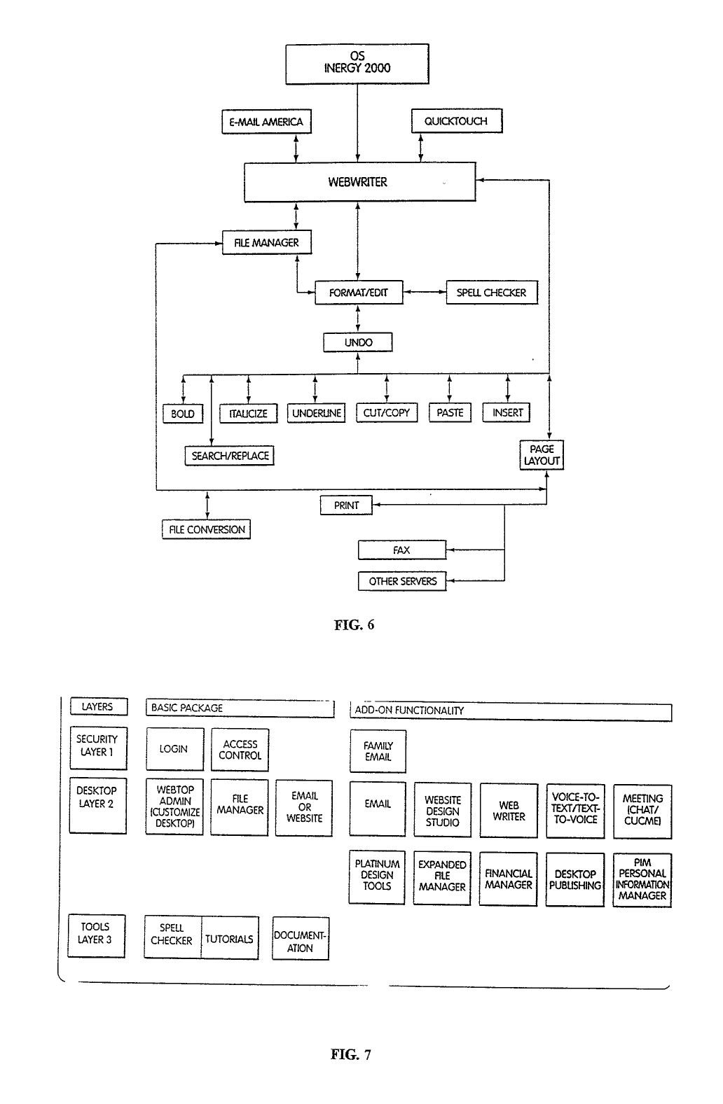

FIG. 7 is a schematic illustration of one application that can be accomplished by the operating system of FIG. 1, namely, a web authoring program, and shows that this application may also be connected to the File Manager, the WEBWRITER, and the spell checker, for example.

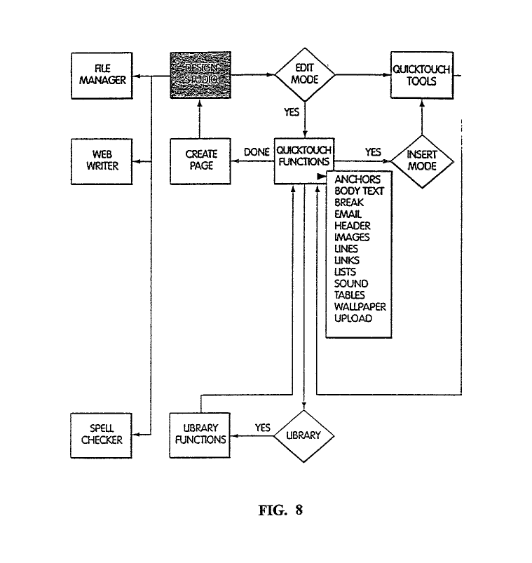

FIG. 8 is a schematic diagram that illustrates another application that may be run under the operating system of the present invention, namely, a word processing program, and includes examples of some of the editing features that may be available, as well as optional connections to other applications, such as to electronic mail, and to tools such as a file manager and a file format conversion application. Printing, faxing, and connections to other servers also are shown.

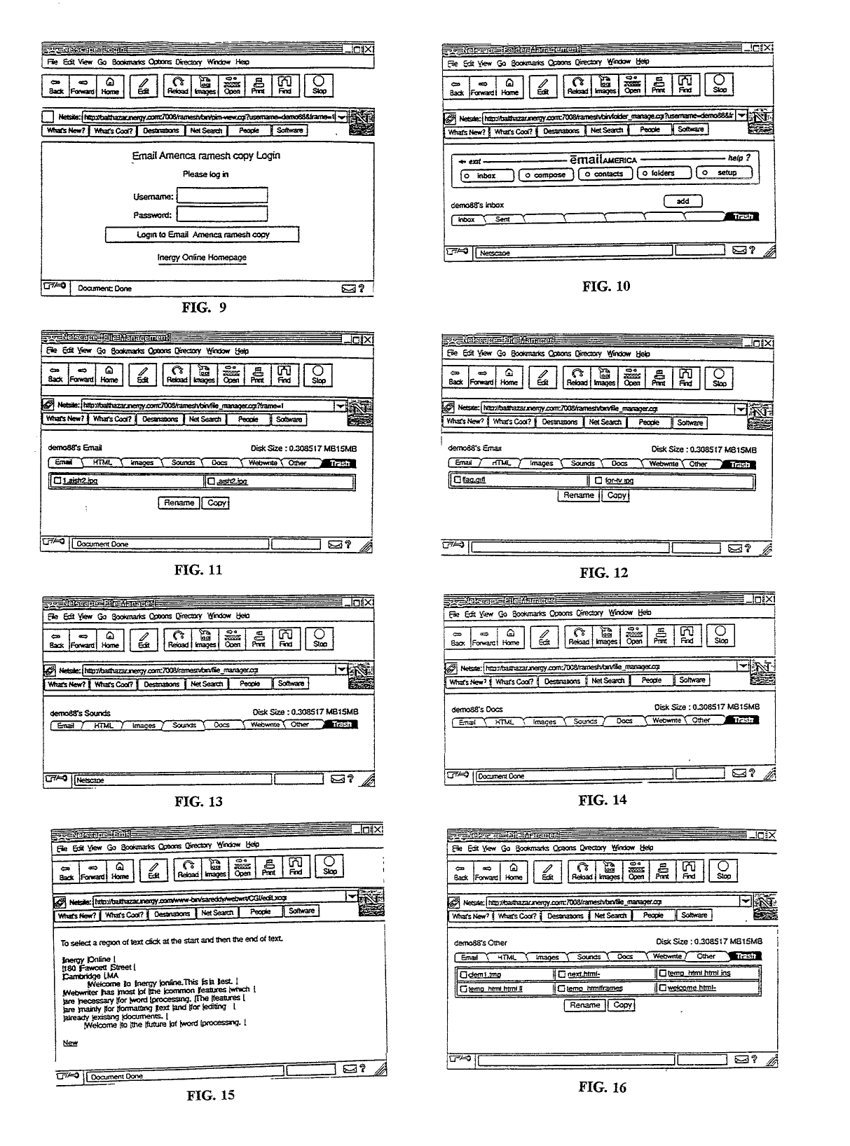

FIGS. 9 through 16 show screen shots of screens that are viewed by the user's browser in an embodiment of the invention, including login, folder management, file management, and editing functions.

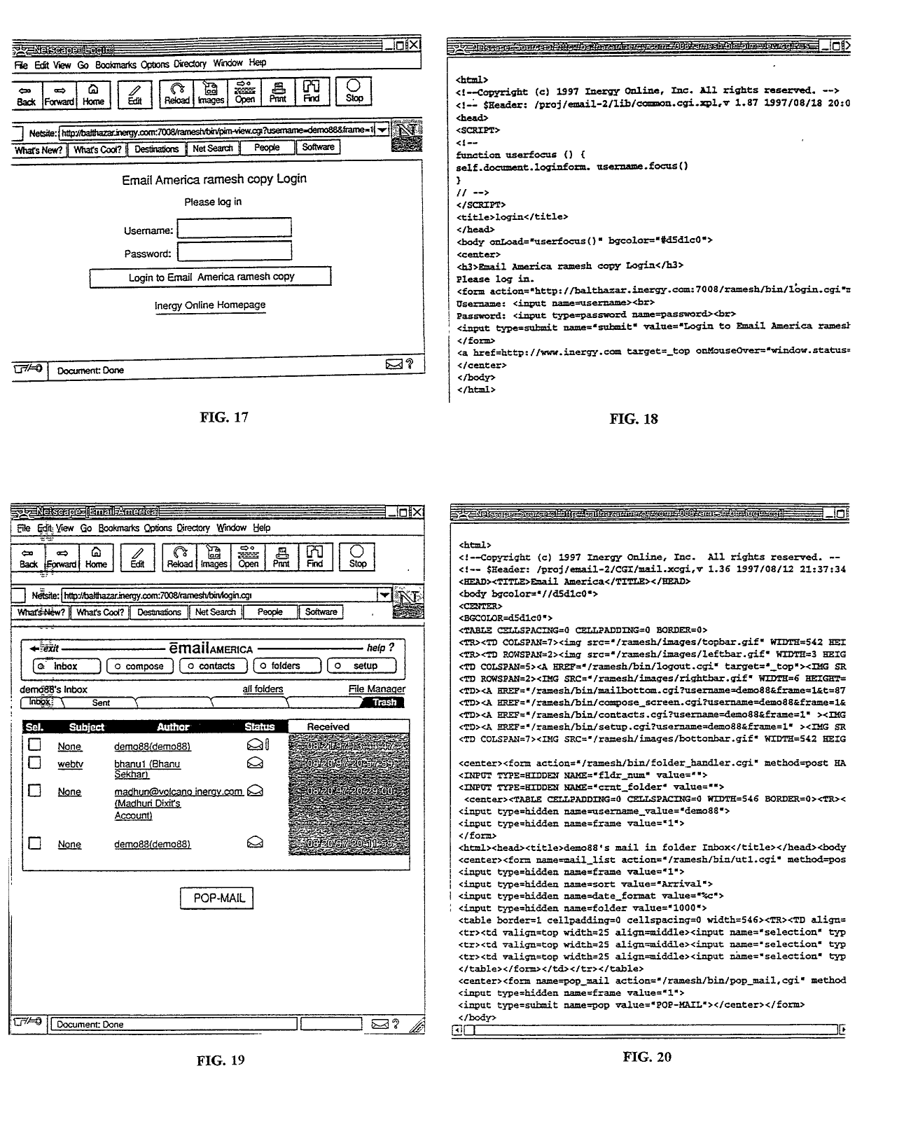

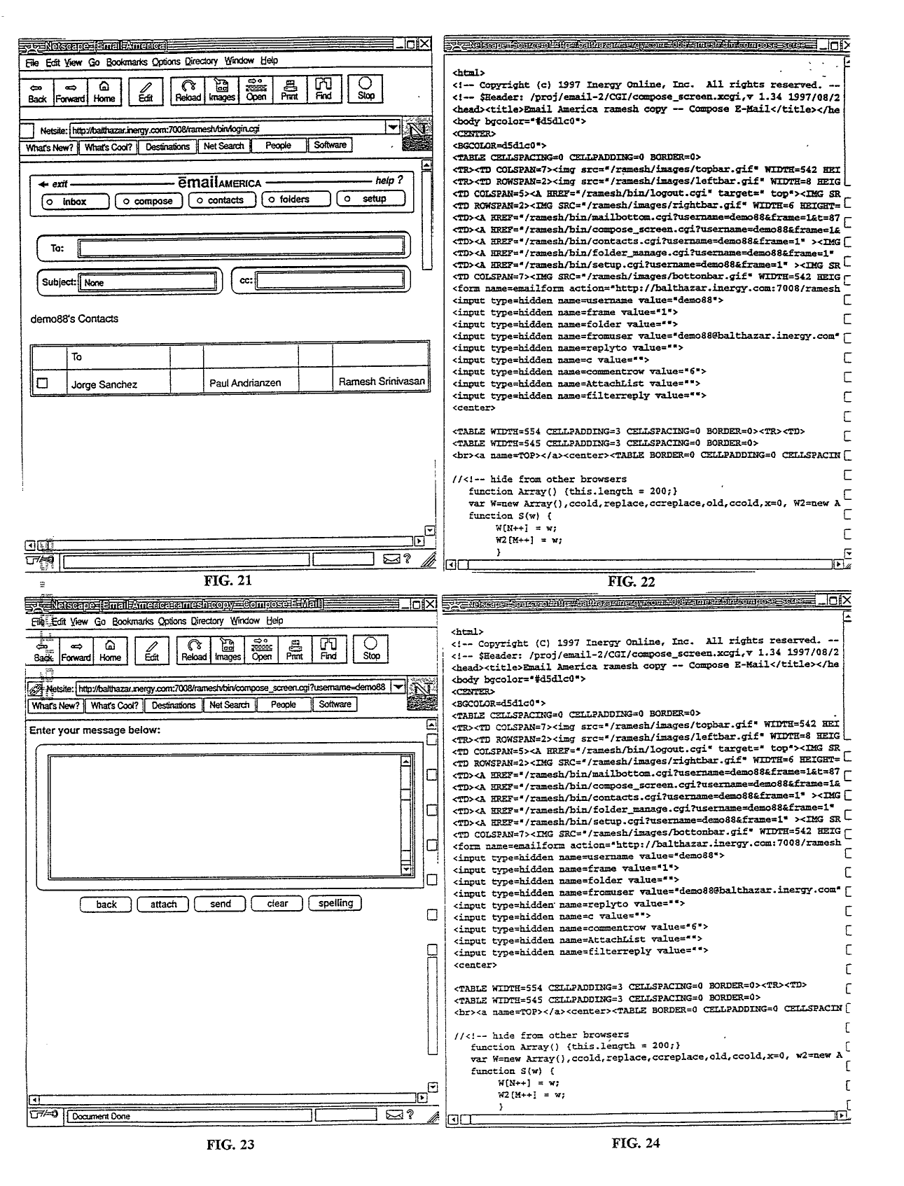

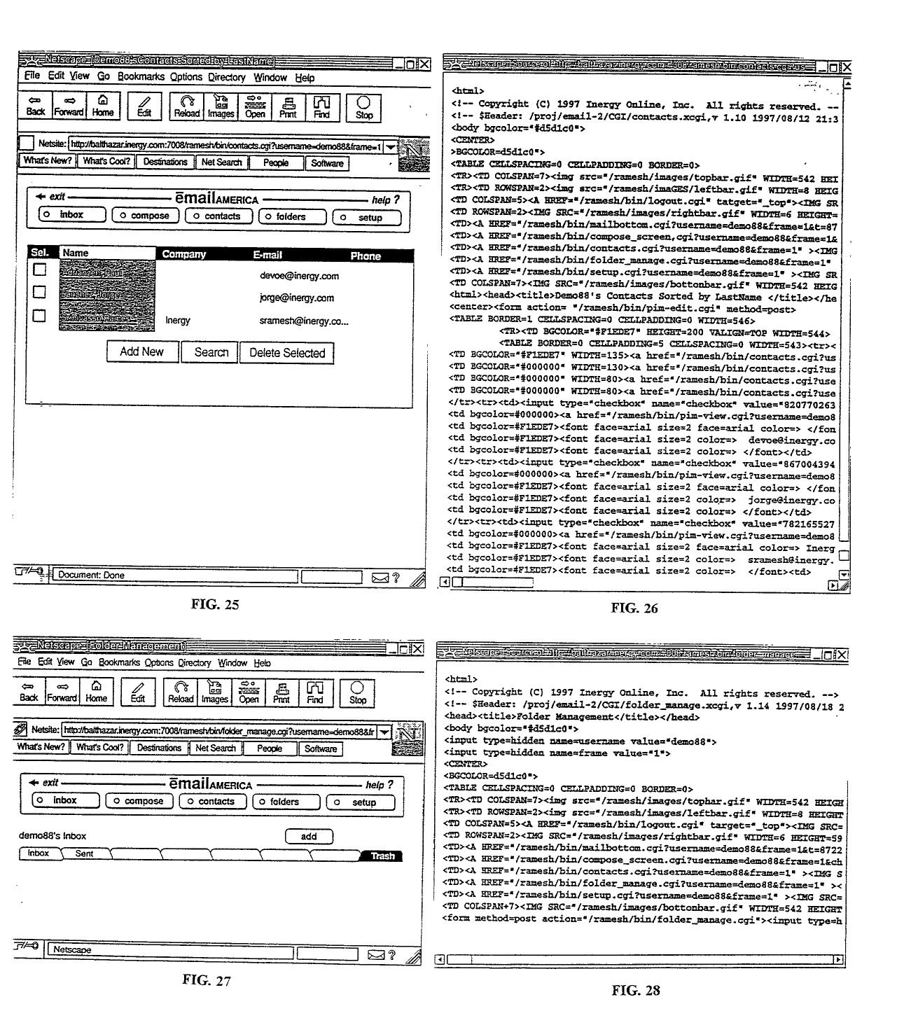

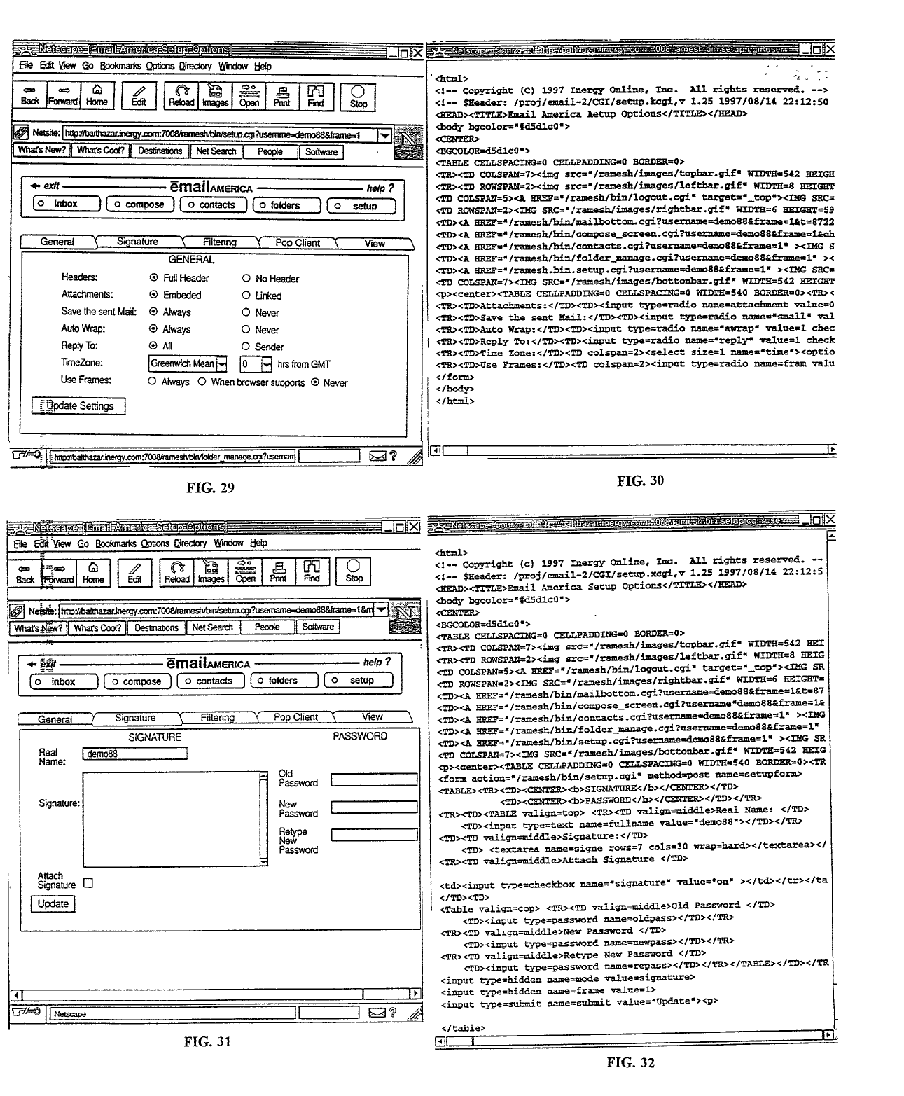

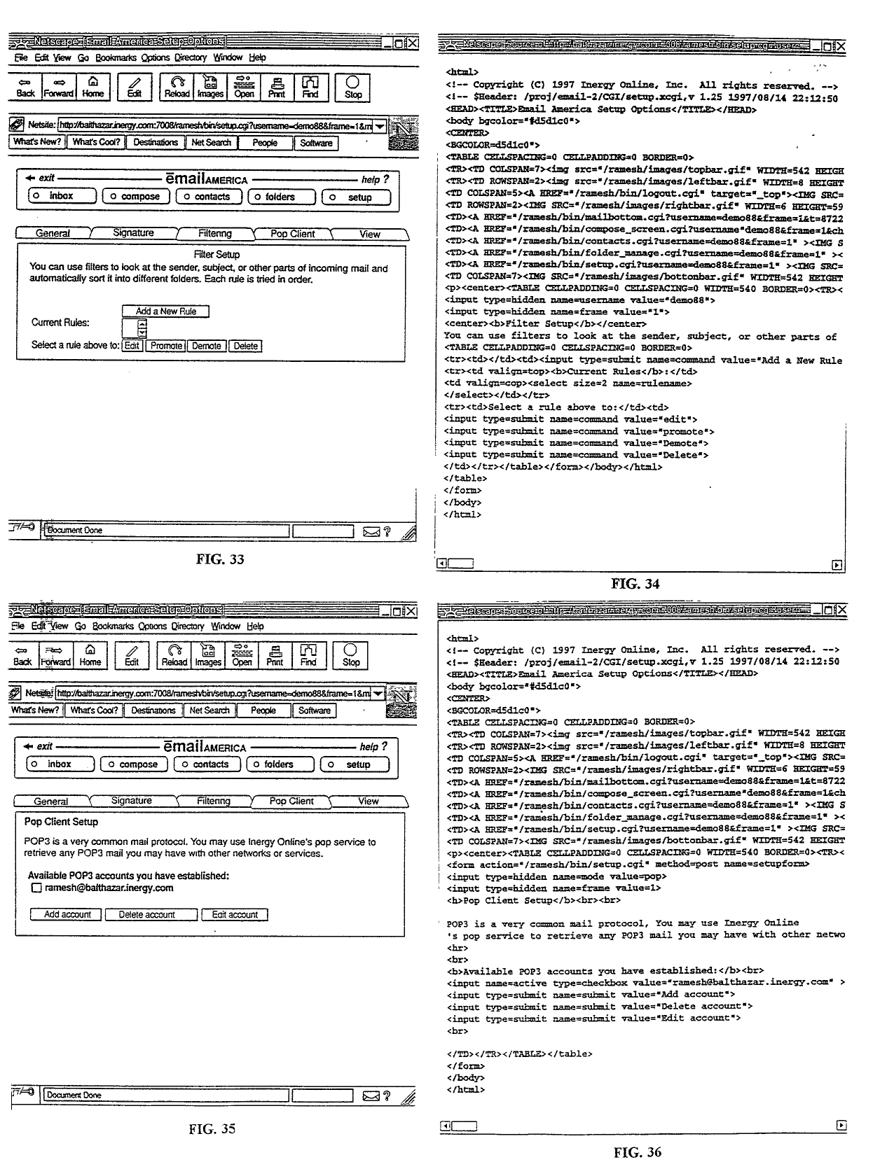

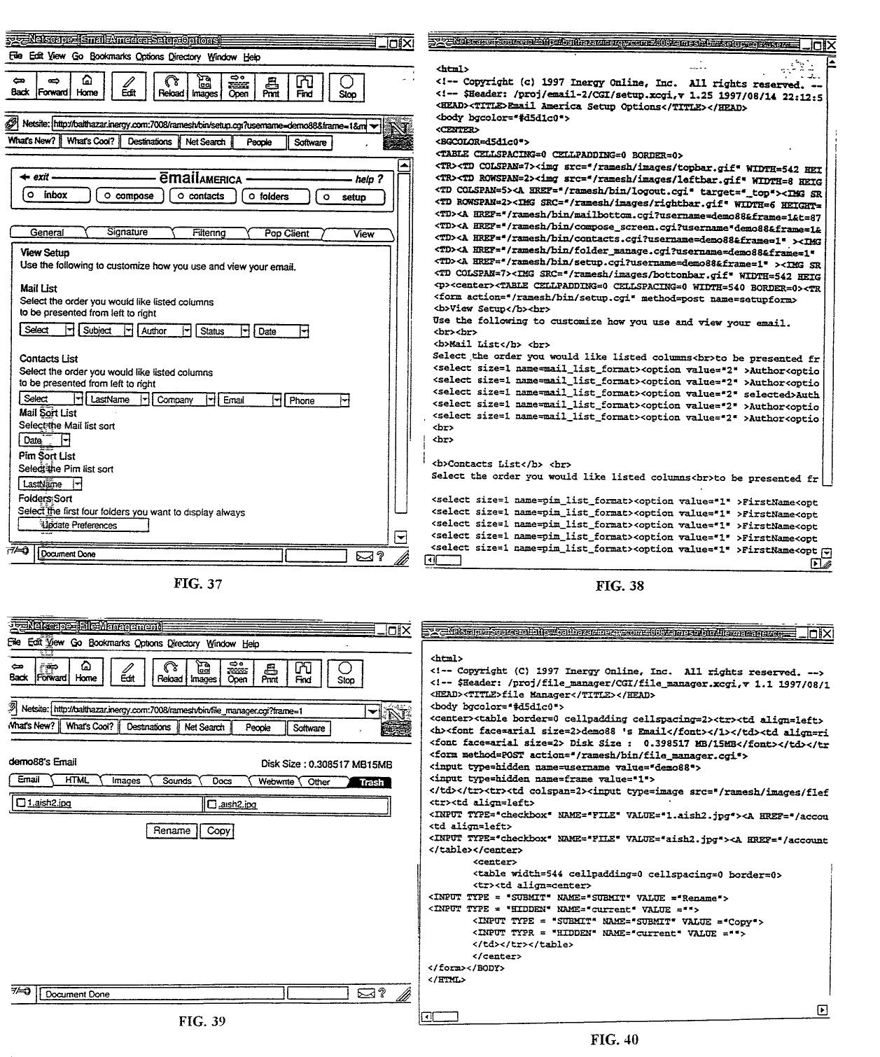

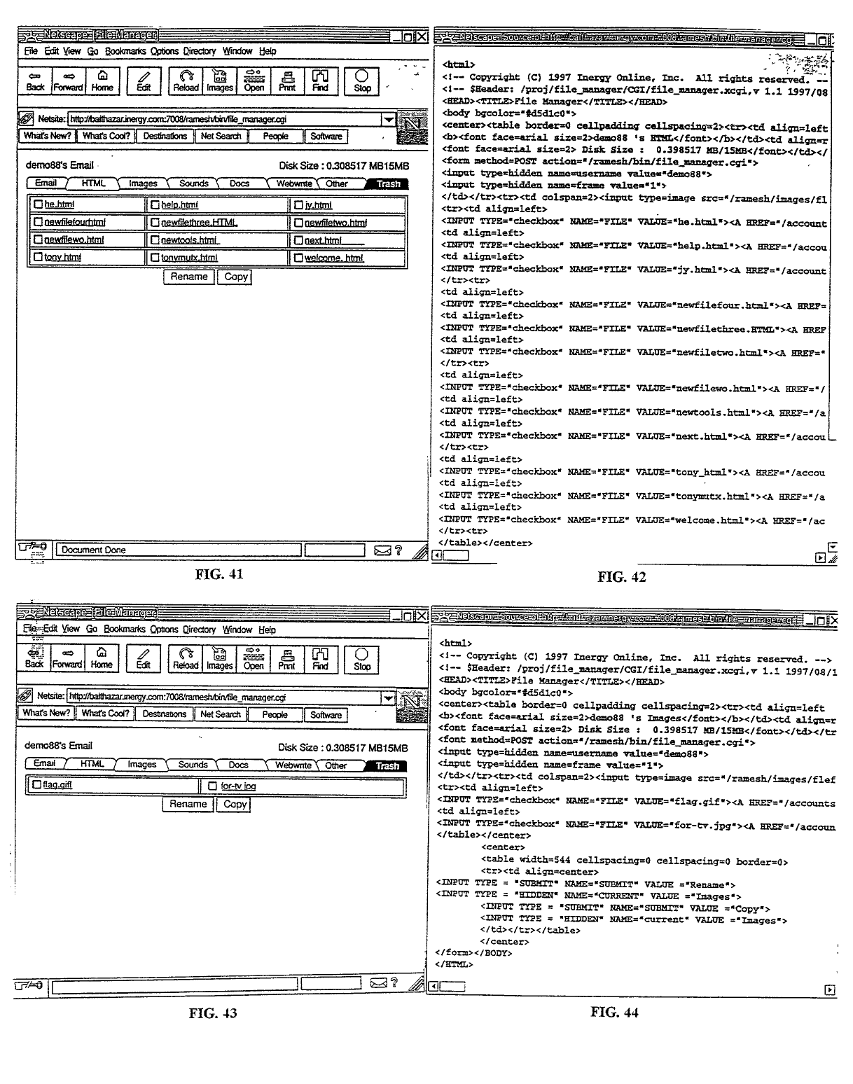

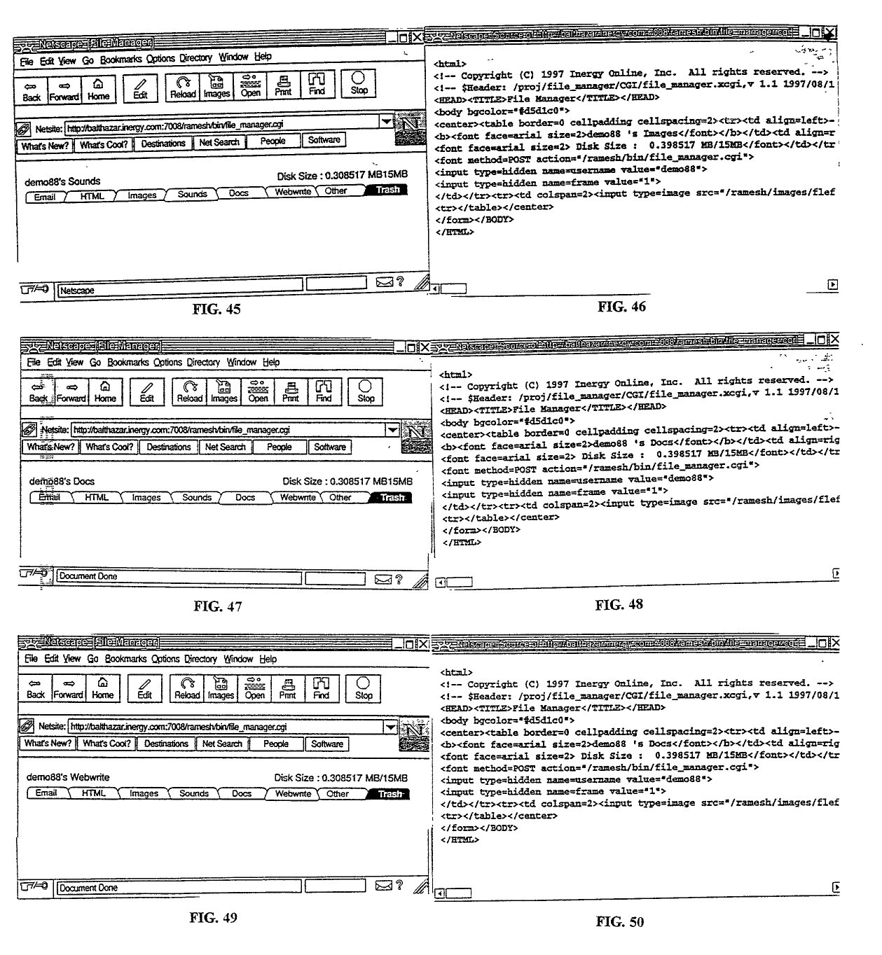

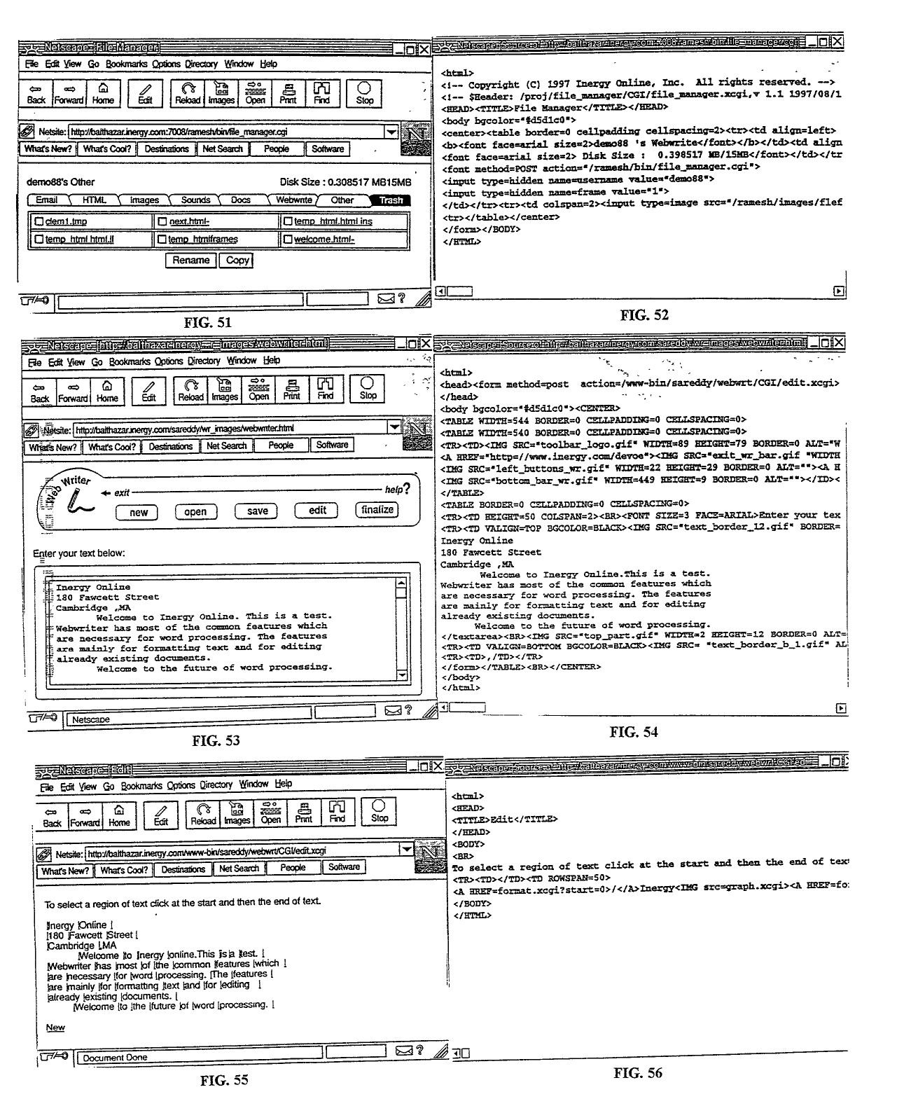

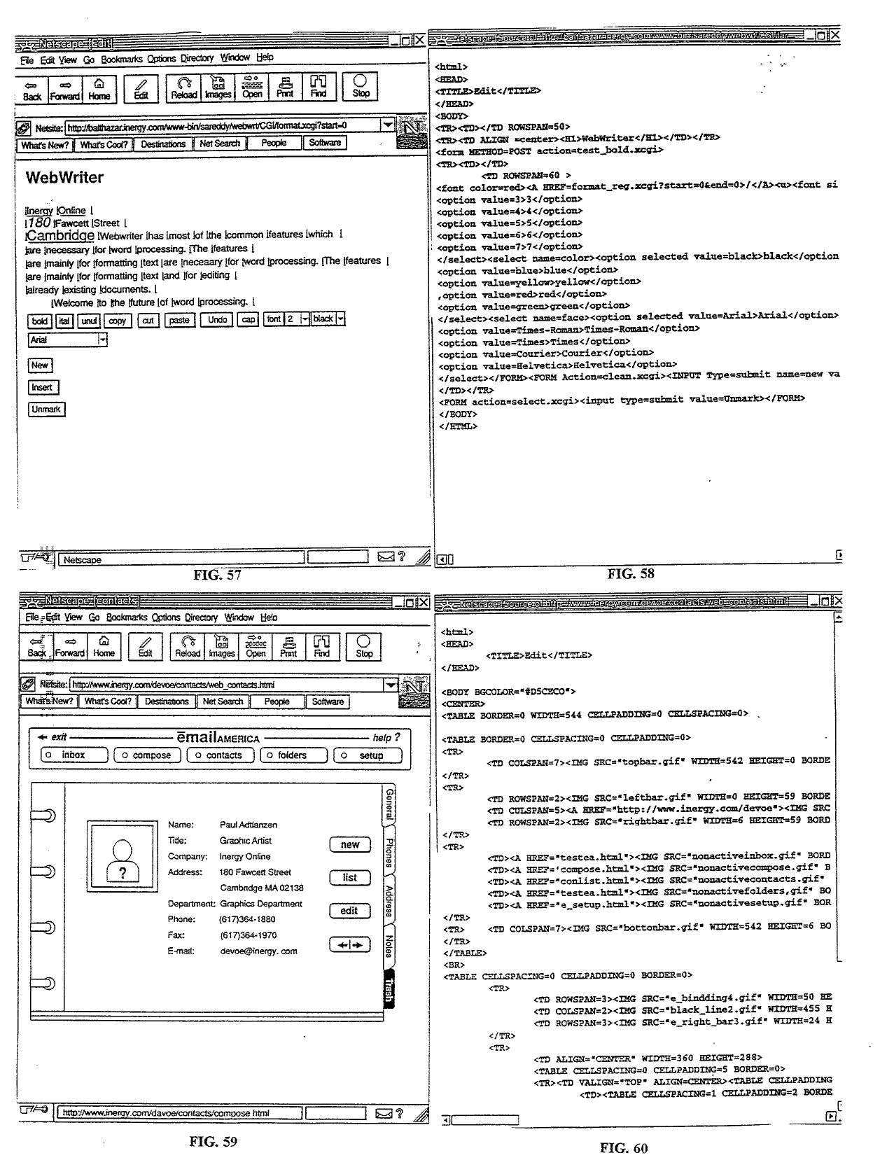

FIGS. 17 through 60 show examples of Web screen shots and the corresponding source code for such screens, according to embodiments of the systems and methods described herein.

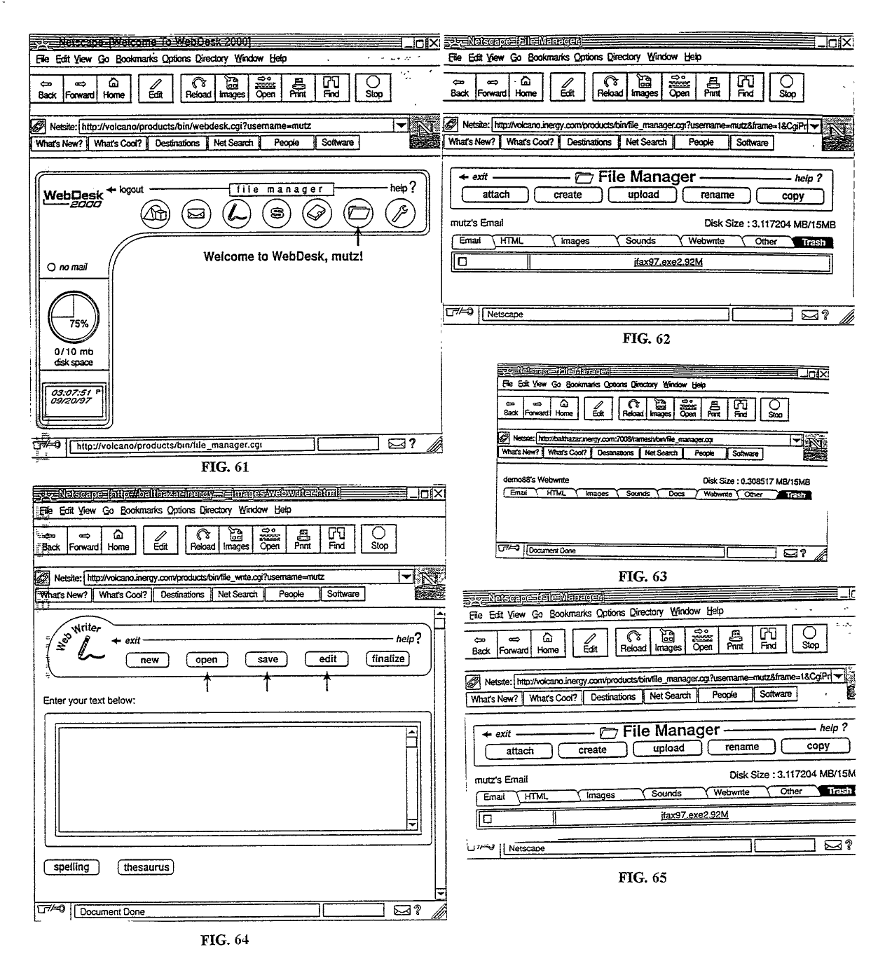

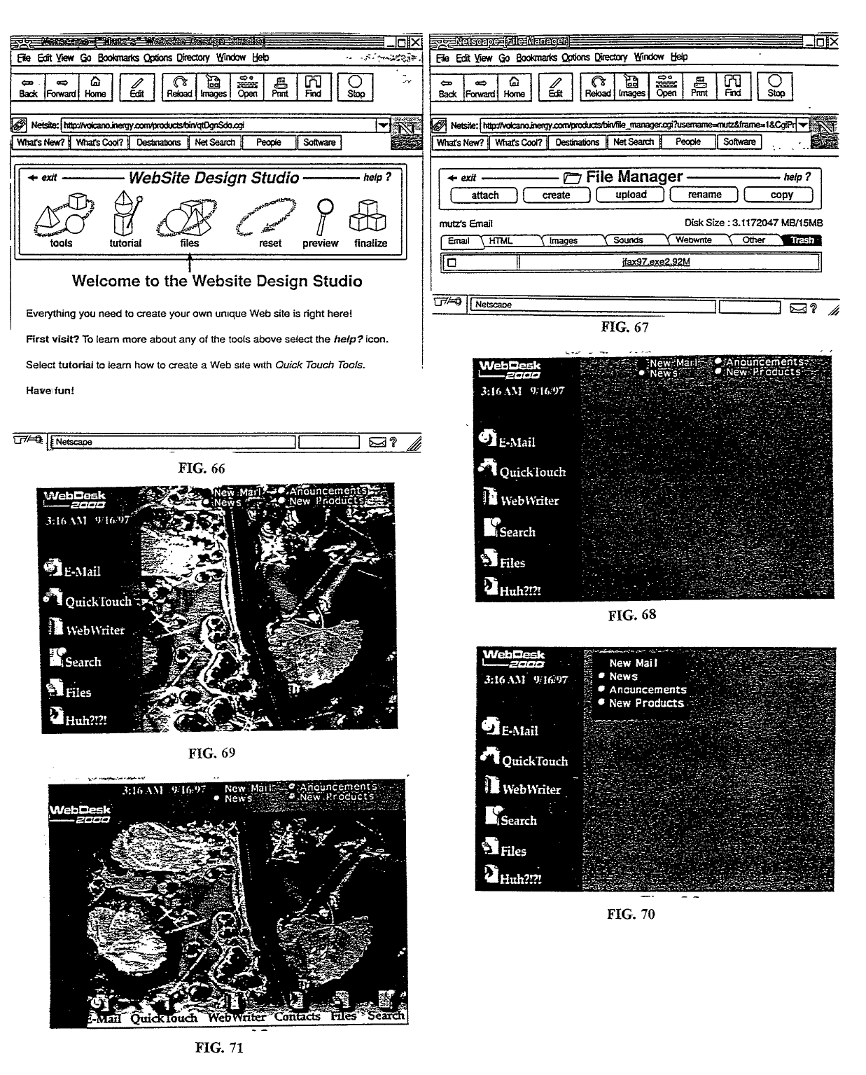

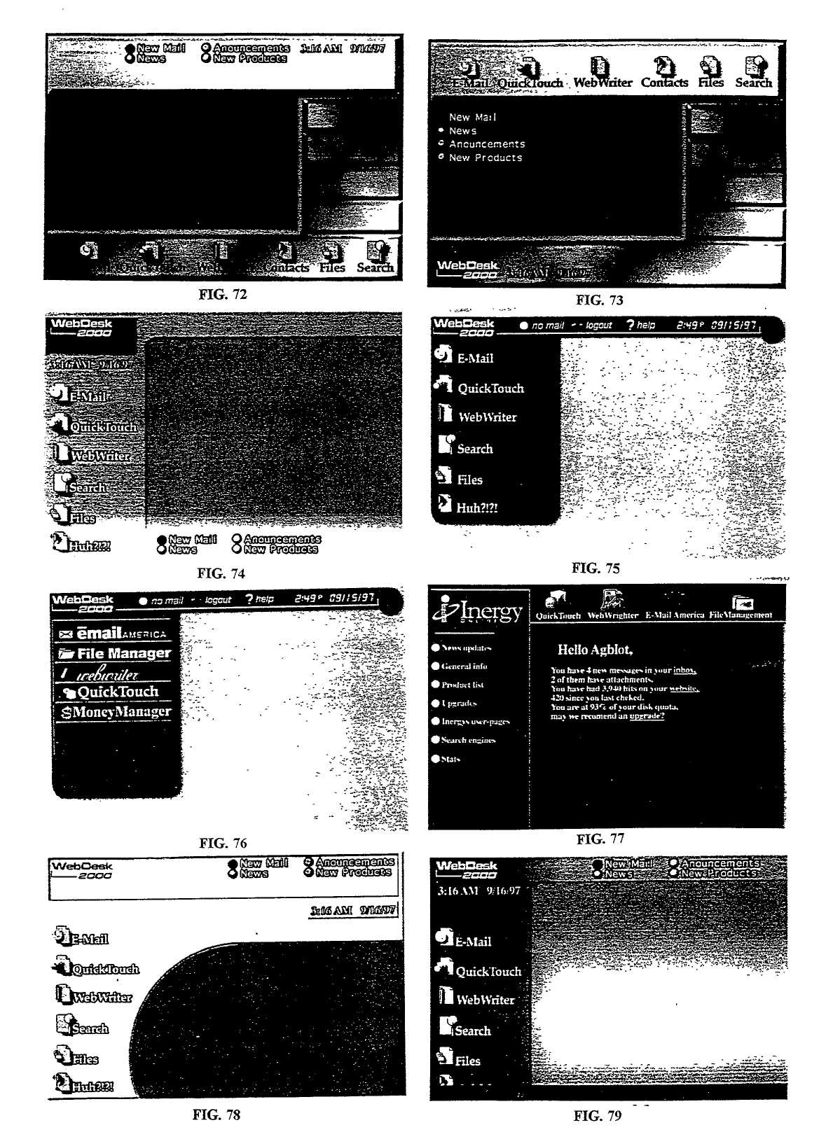

FIGS. 61 through 79 show examples of Web screen shots according to embodiments of the systems and methods described herein. The screen shots reflect functions accomplished by the operating systems of the present invention.

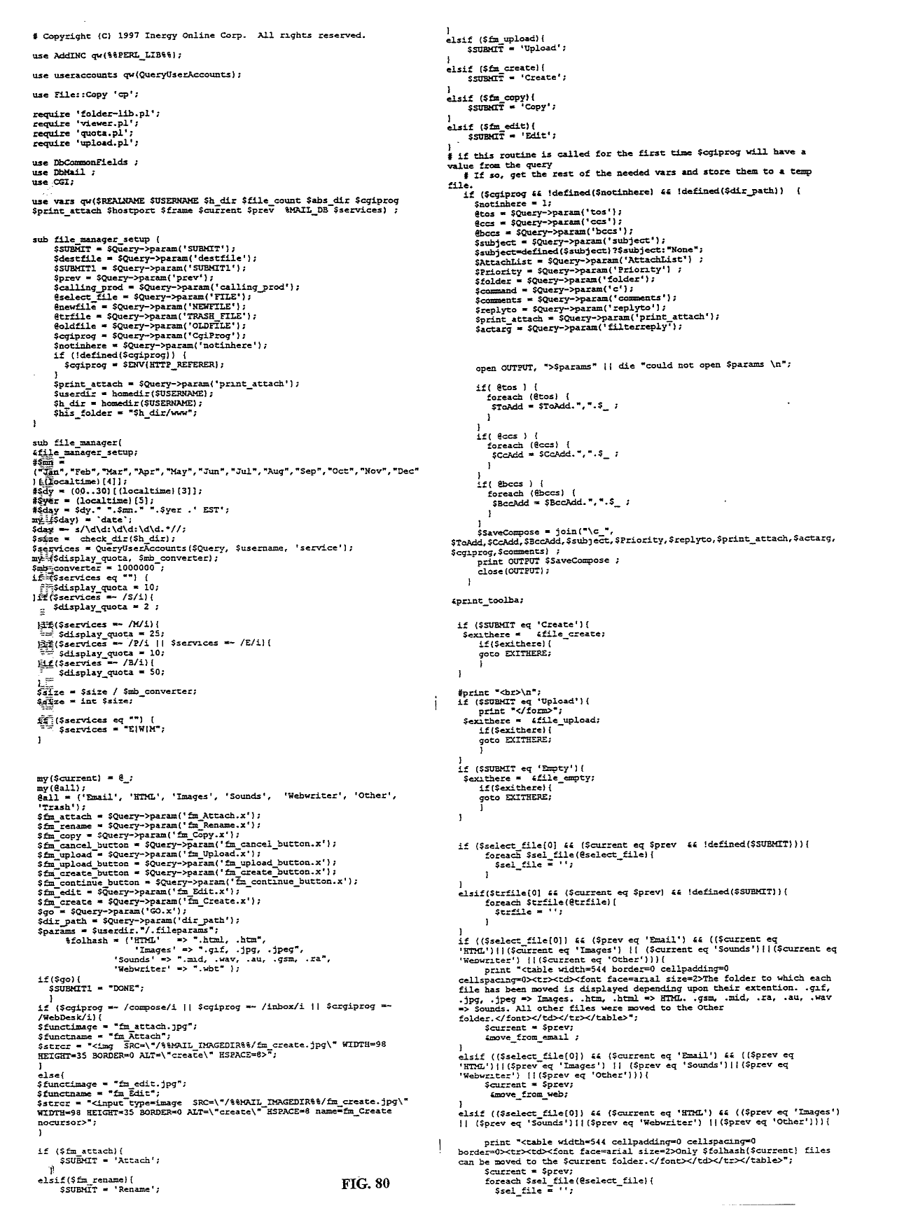

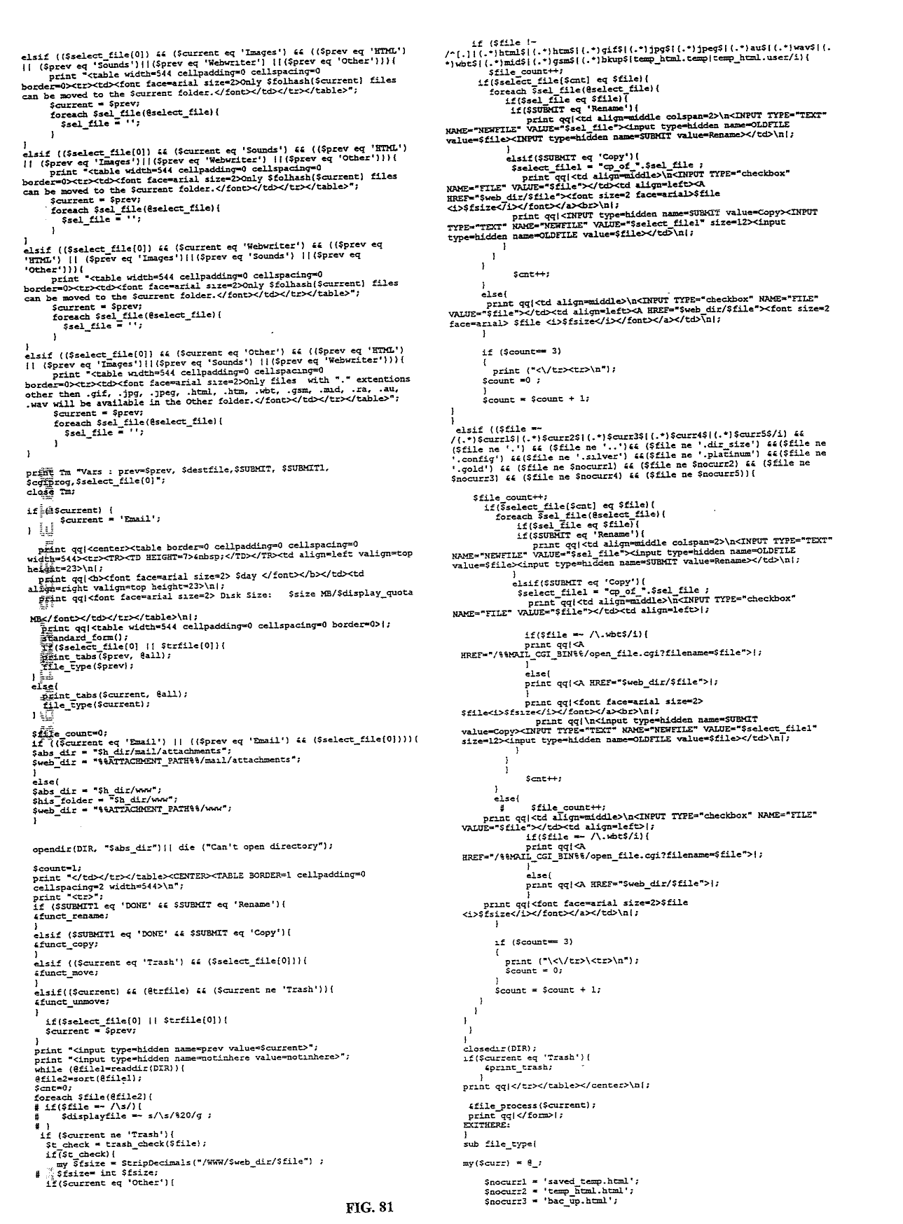

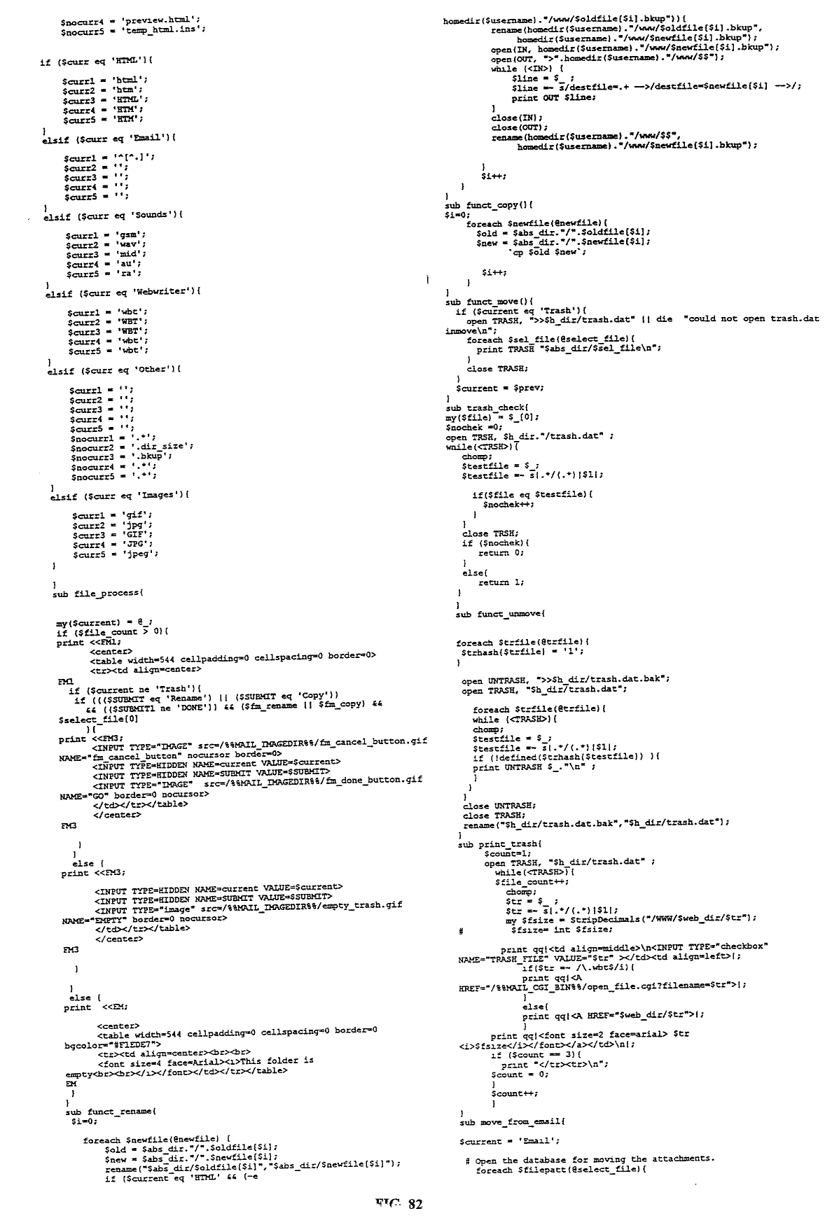

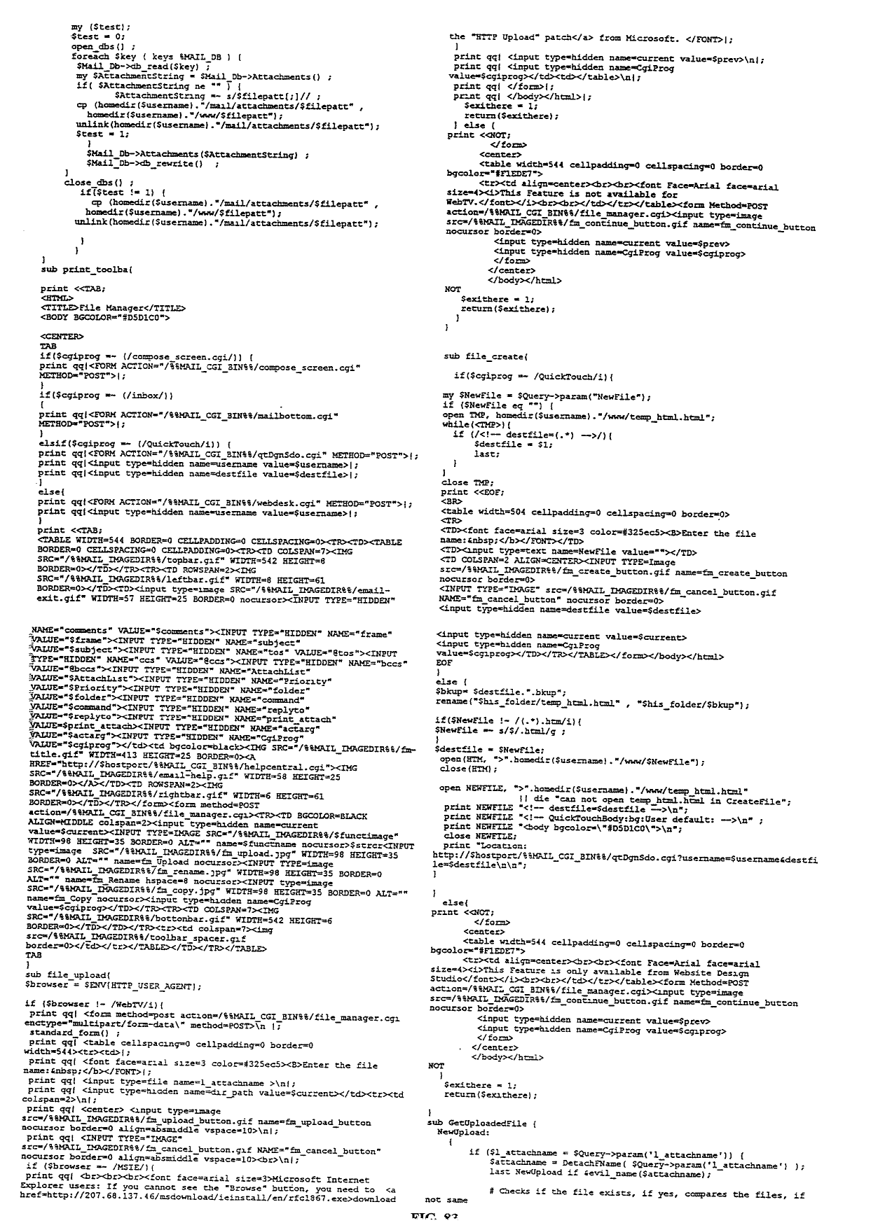

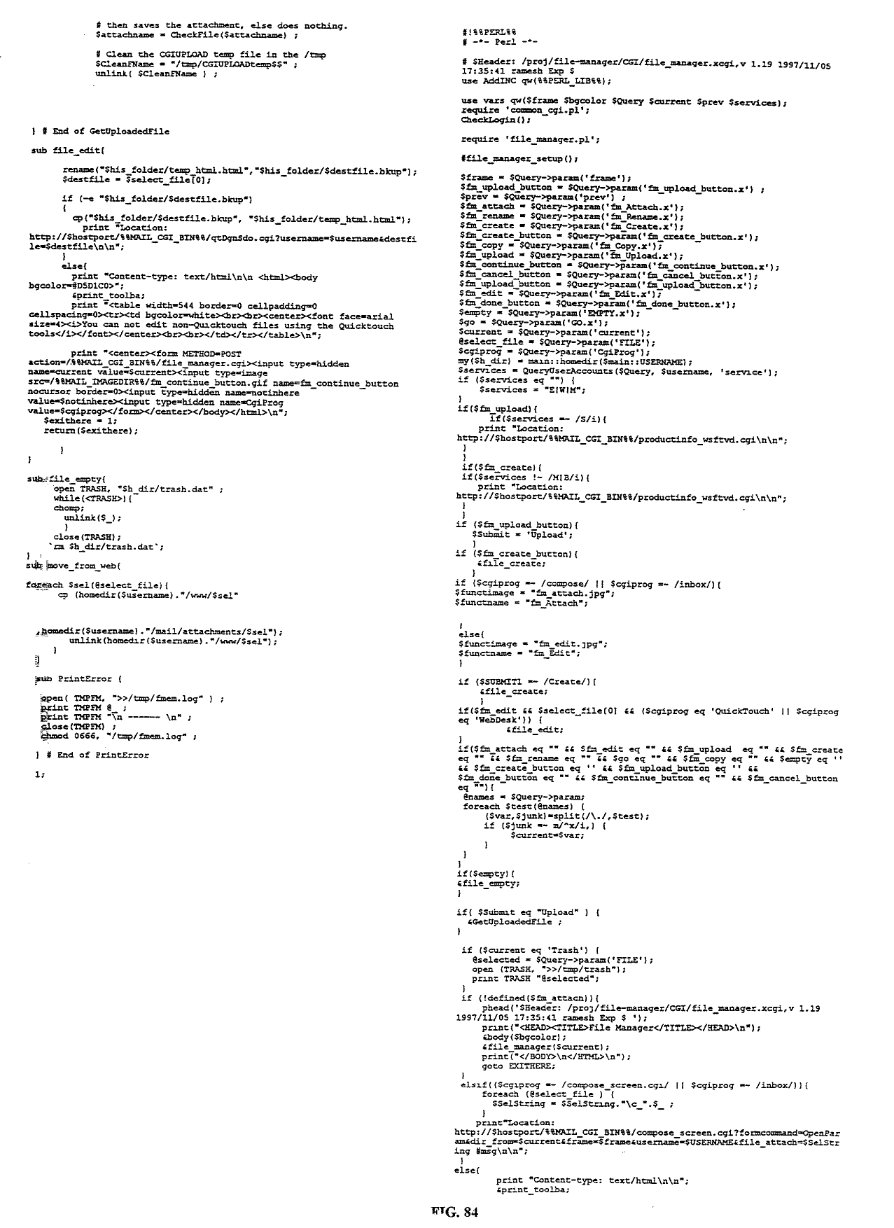

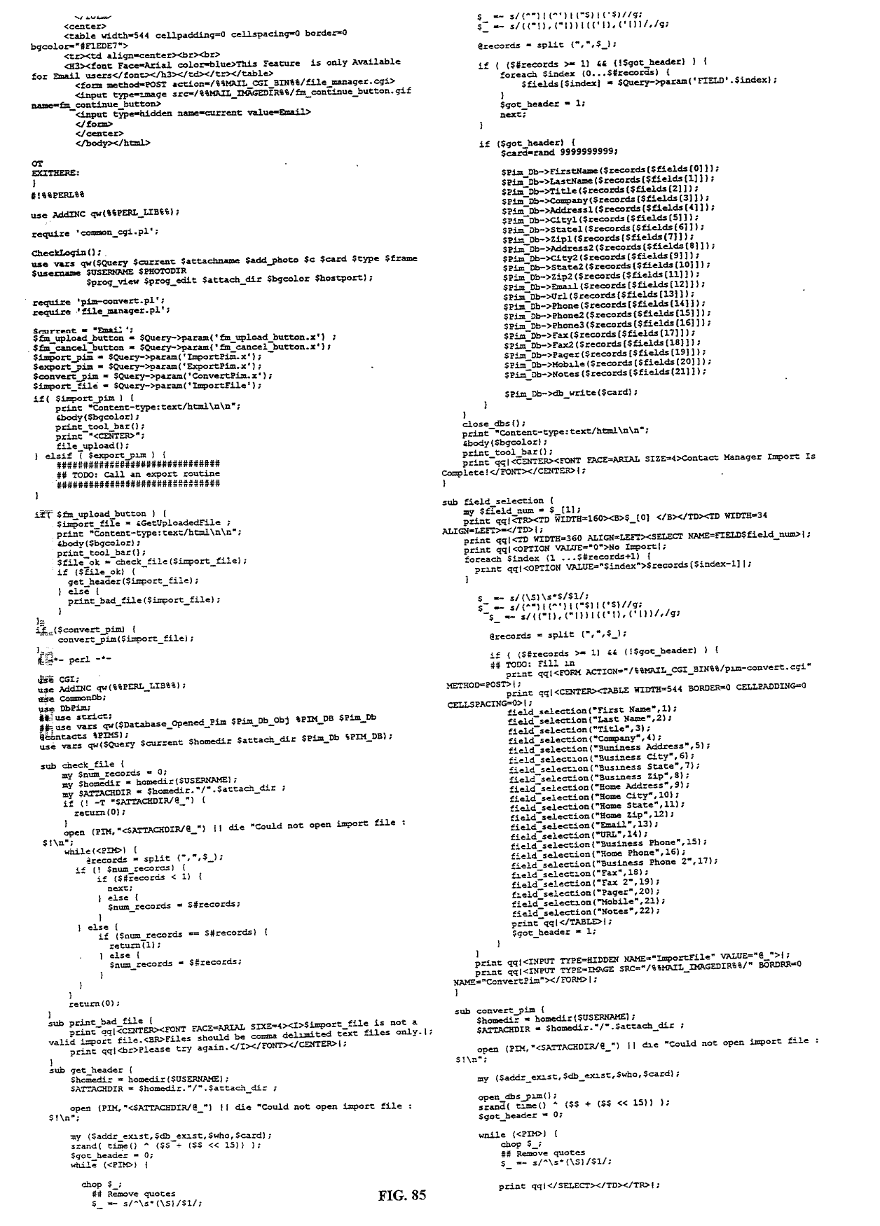

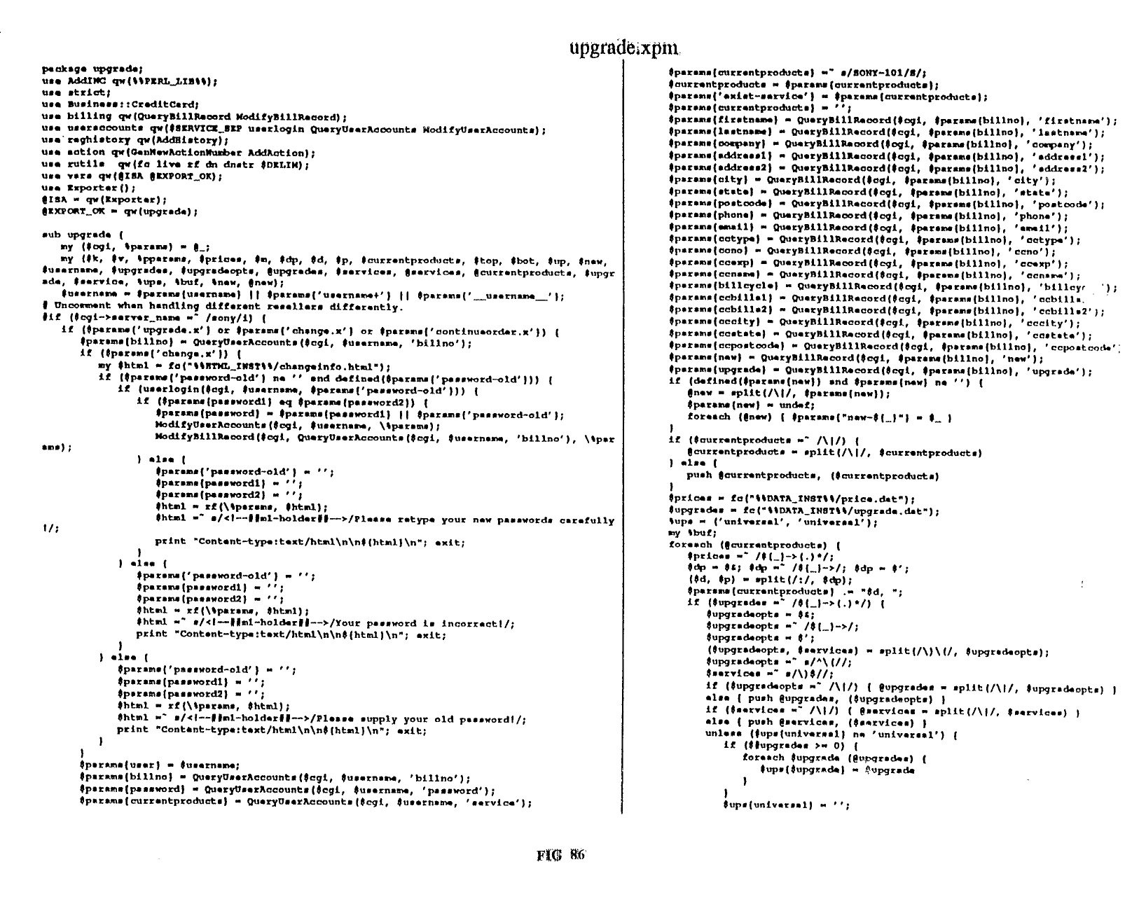

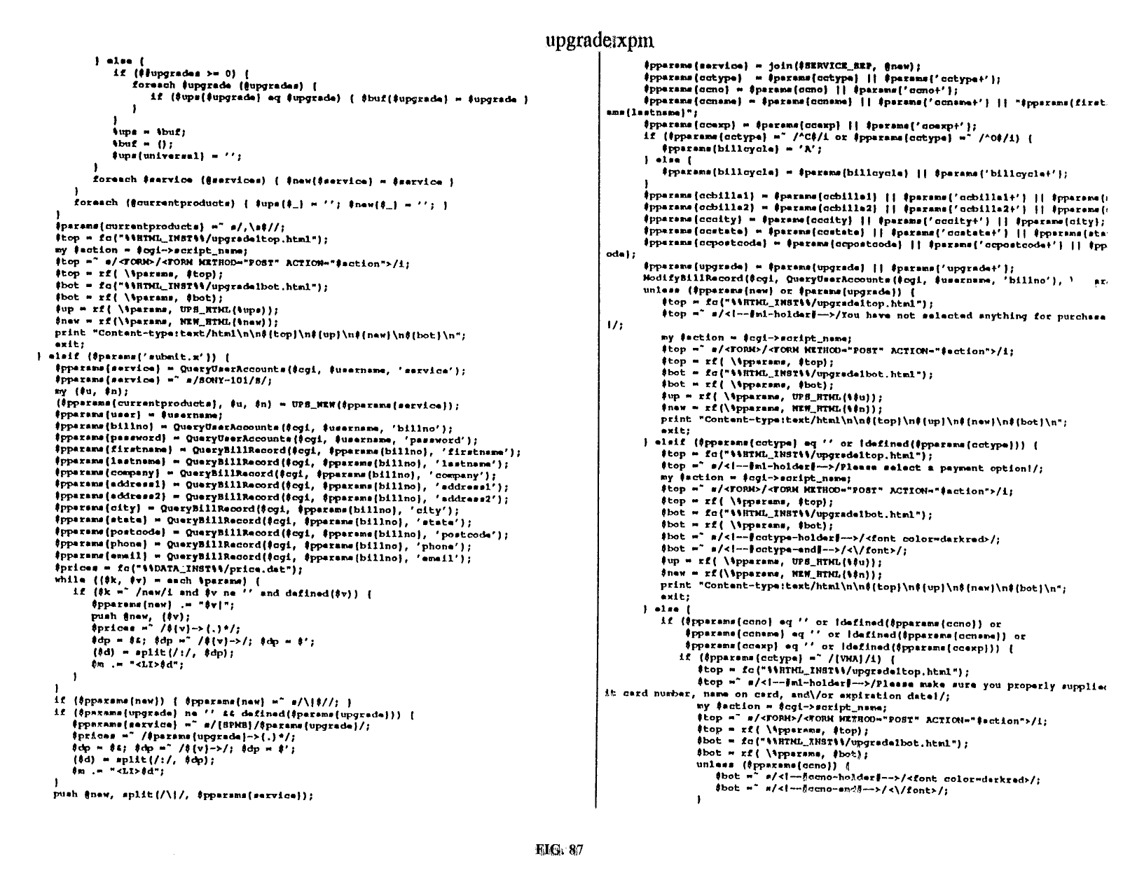

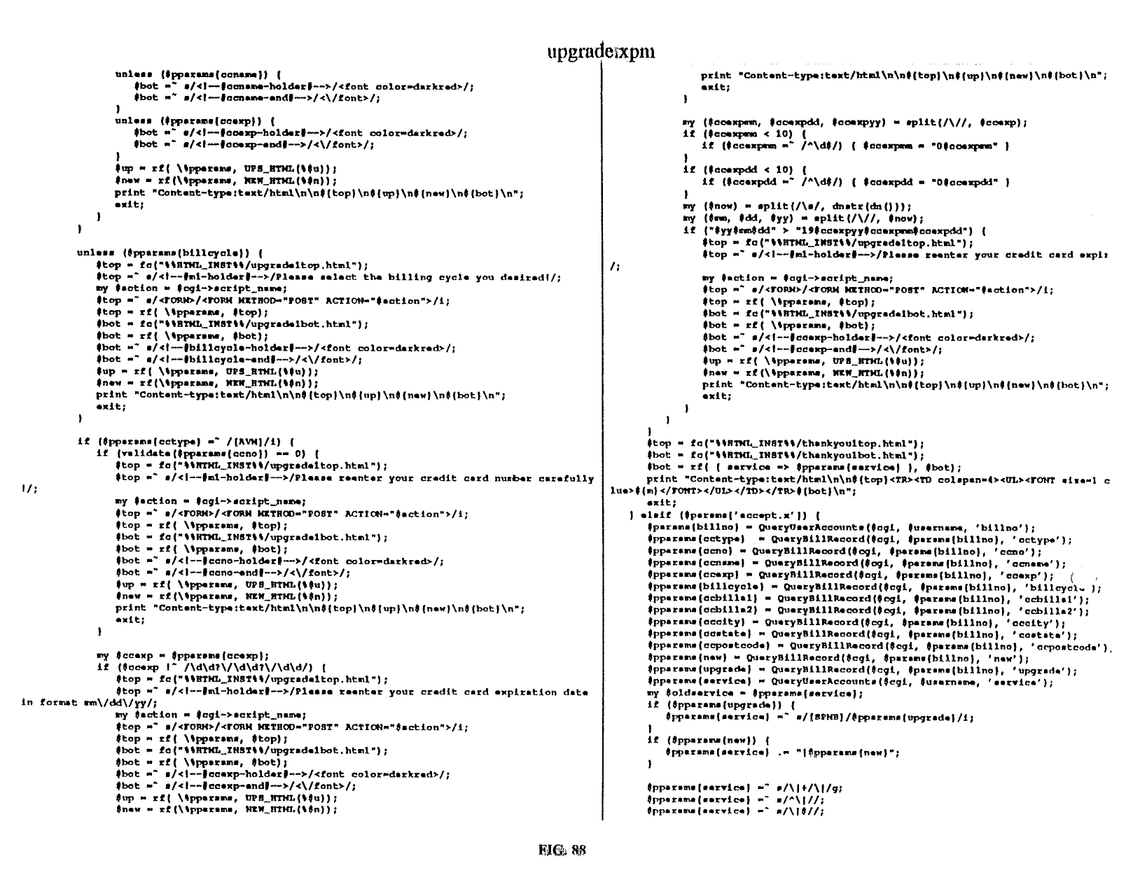

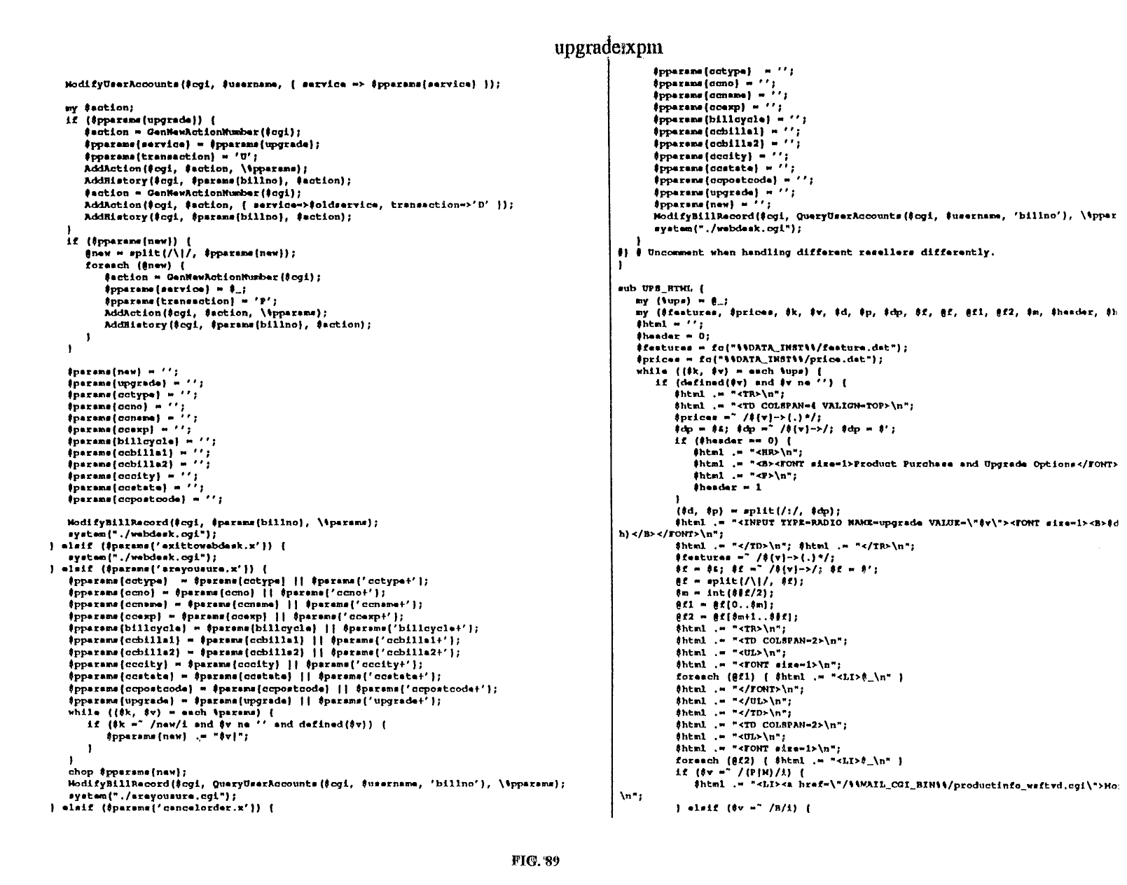

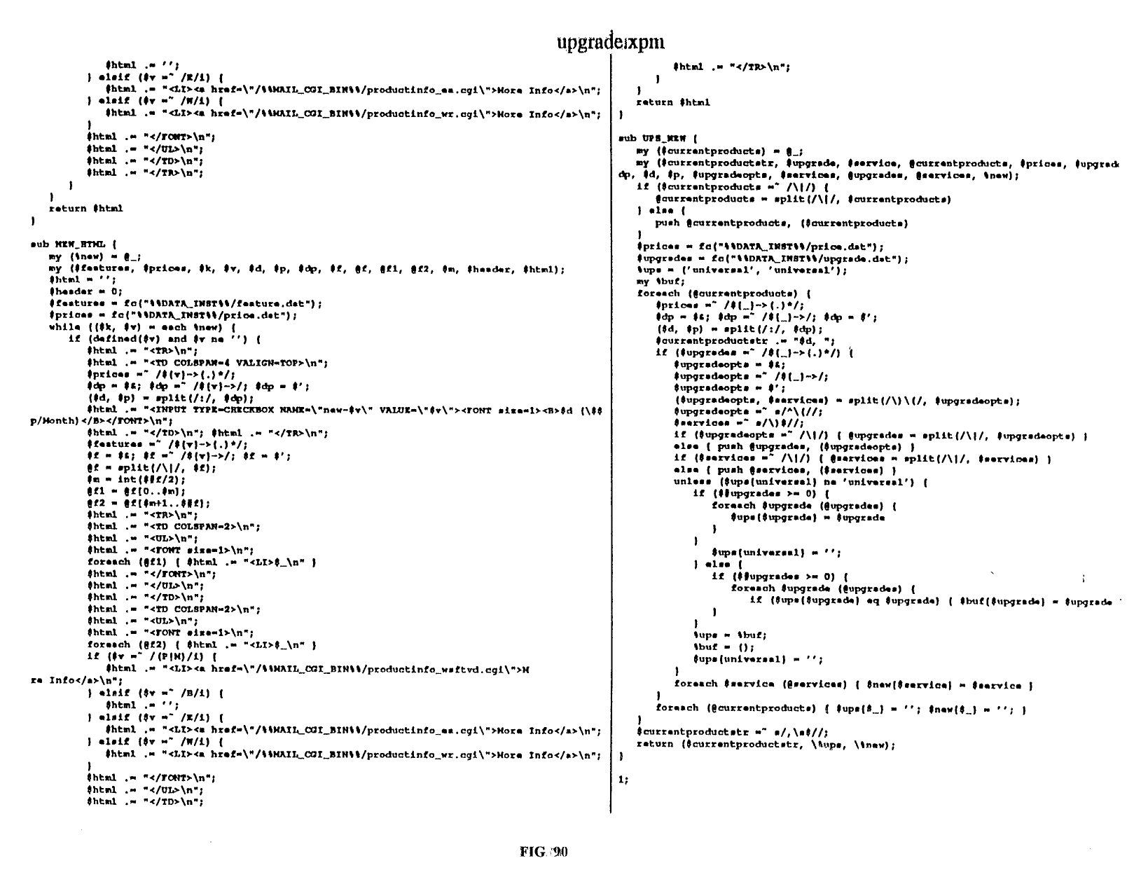

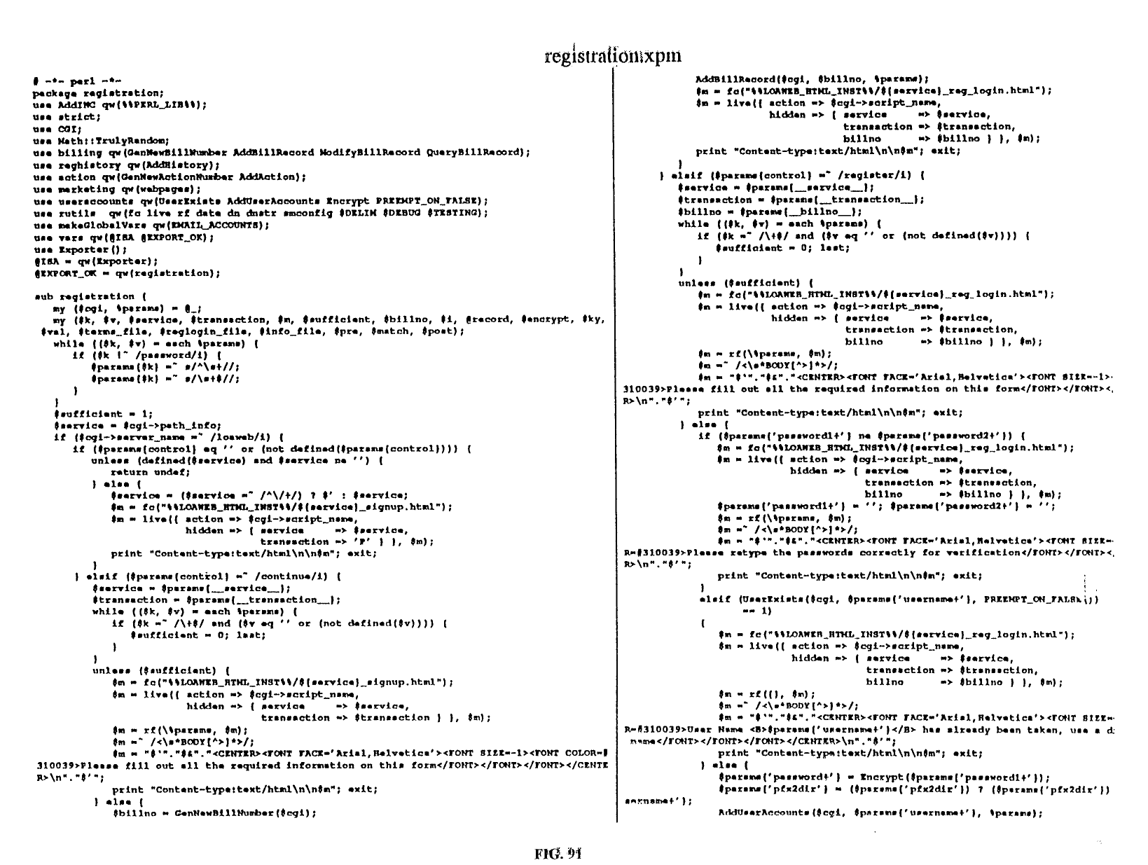

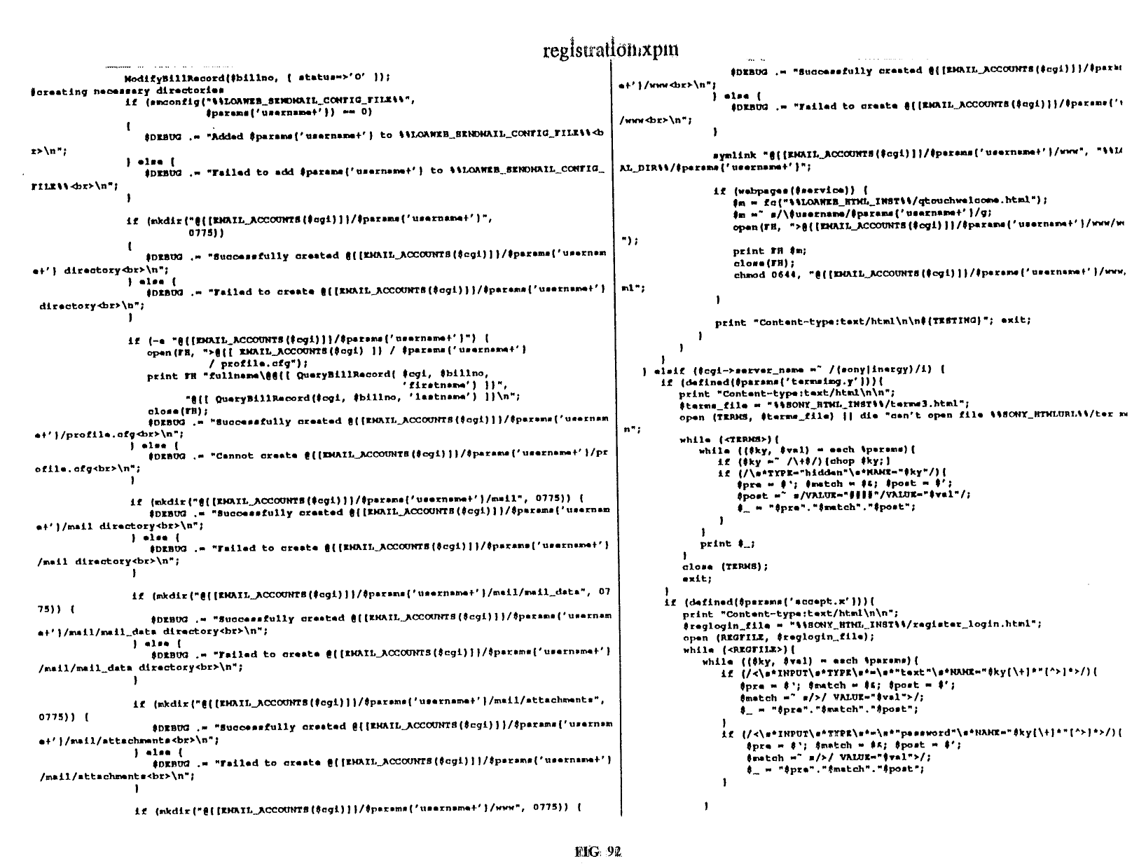

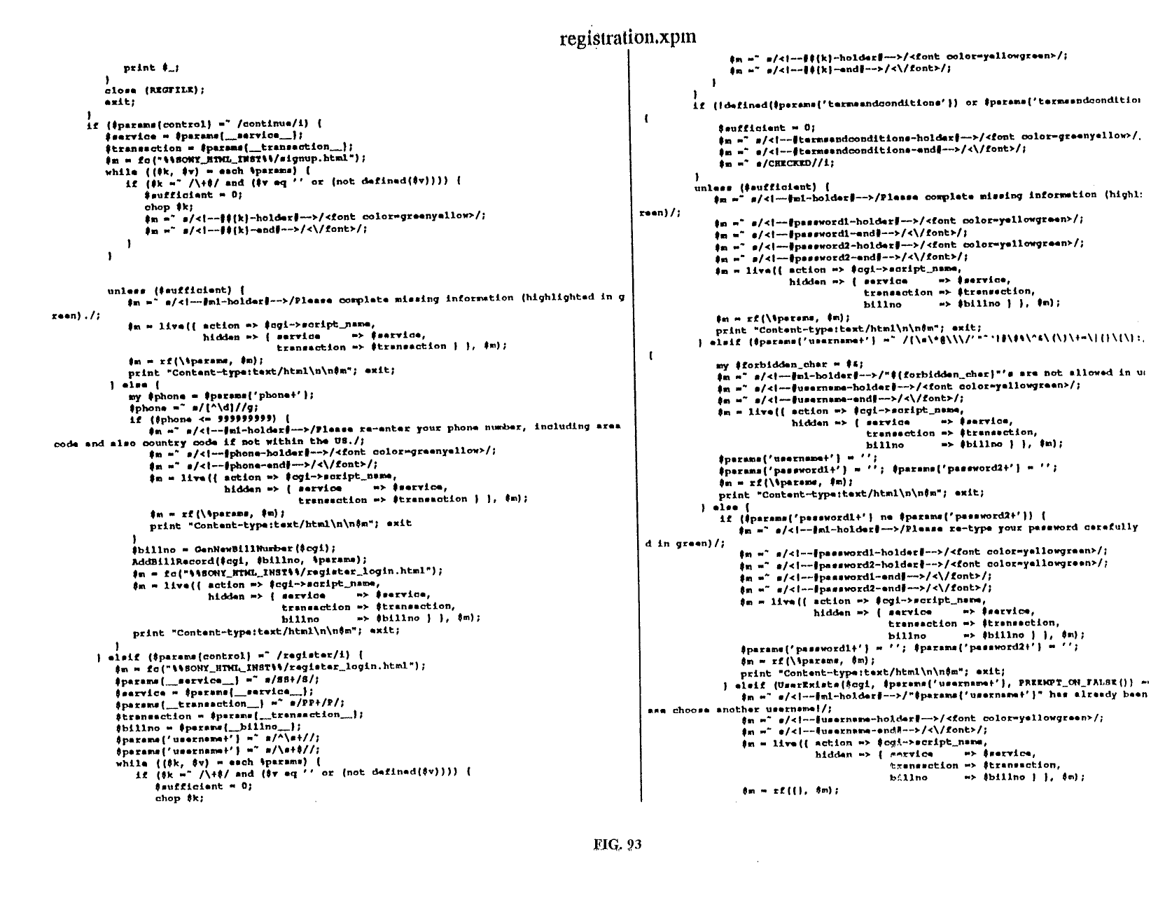

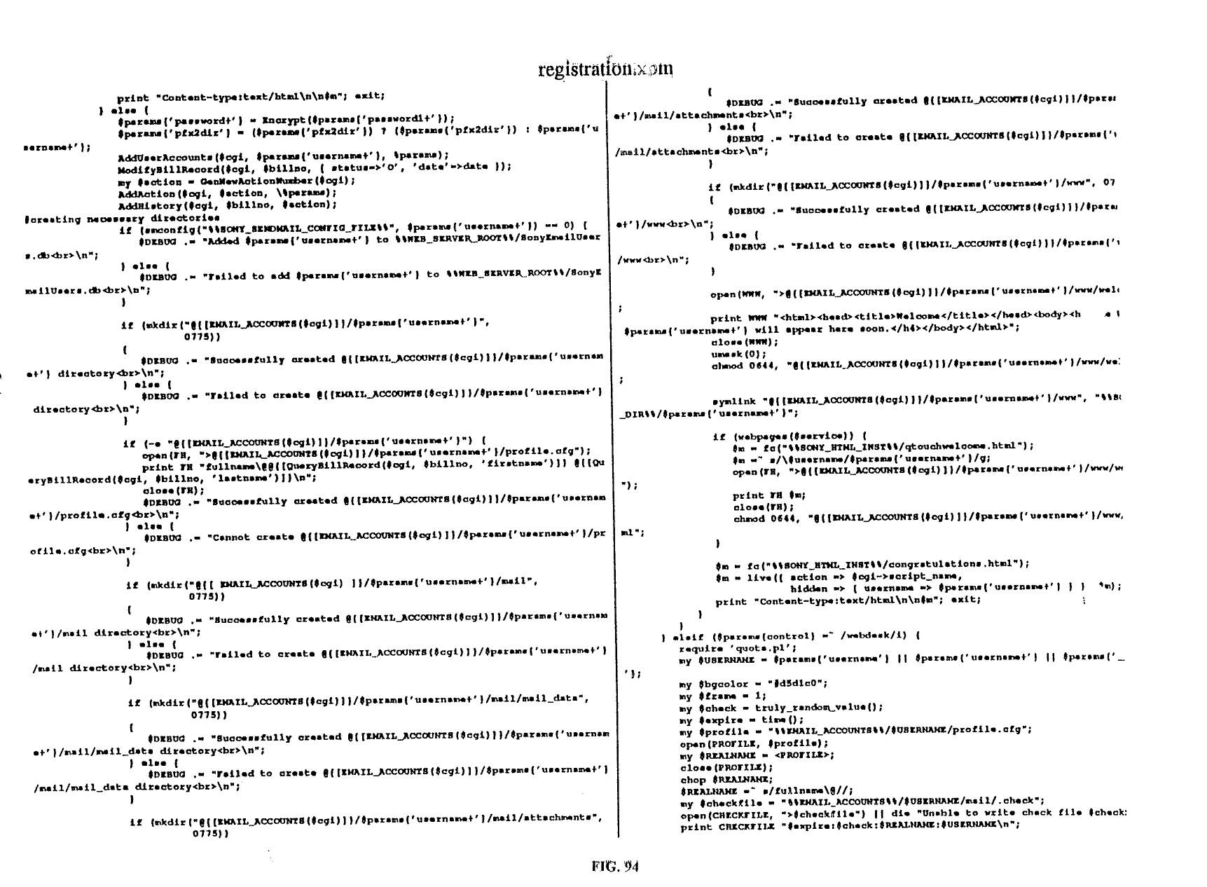

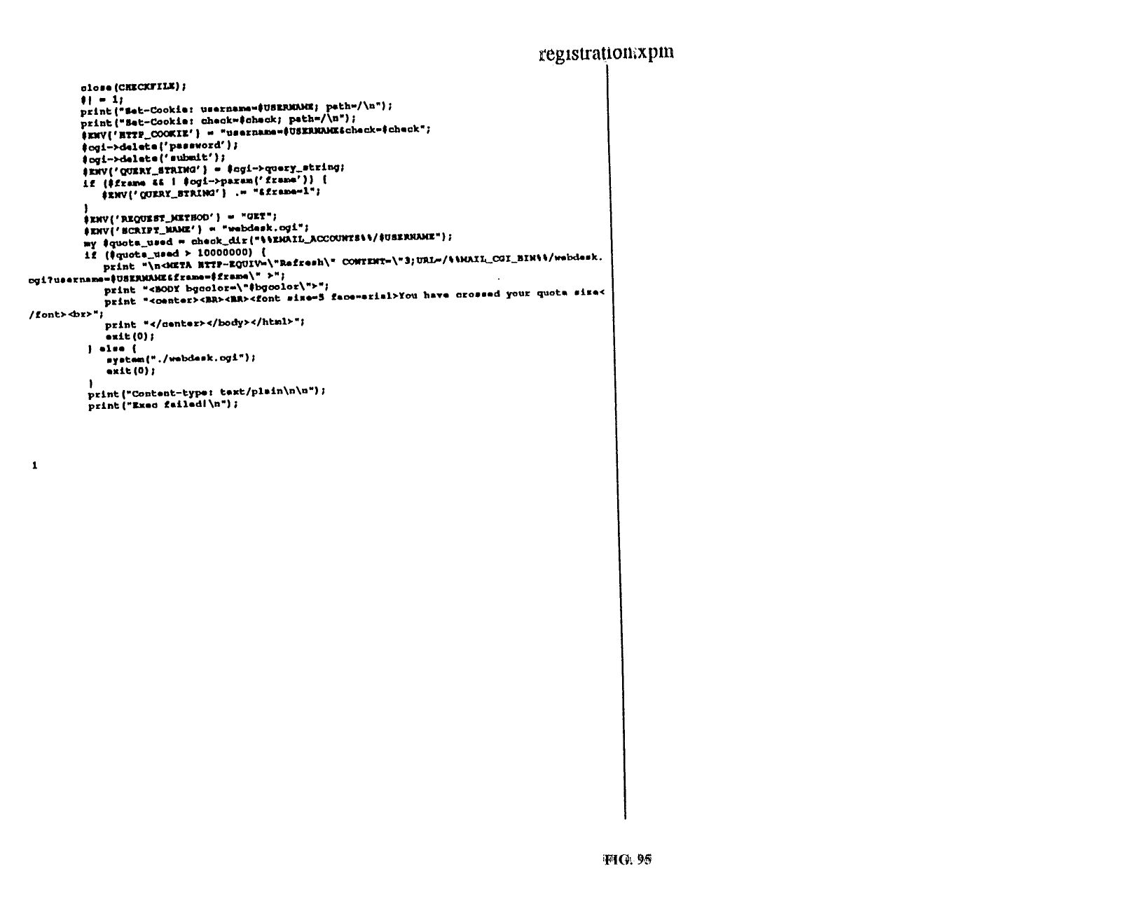

FIGS. 80 through 95 depict source code for embodiments of an operating system of the present invention.

Another advantage of the operating system disclosed herein is that no particular Internet Service Provider (ISP) is required. A user may continue to receive messages at the same address (located on the server 24), with no interruption, even if the user switches ISPs, technologies, computer terminals, or televisions, or if the user moved to a different location. The user would not lose messages if the user's laptop or portable computer were stolen, because the messages would reside on the system's server and would be backed-up automatically.

Another advantage for the user would be that, because all system software is provided directly at the system's Web site, all enhancements are provided at a centralized location rather than having to periodically provide each user with updated software. The user does not need to upgrade software.

The system may include additional features such as the ability to convert files received from many types of systems to HTML and TXT, support for embedded application files that includes automatically executing the corresponding application, an address book that automatically addresses a message to send when an address entry is selected, and general access to a list of registered system users. the PIM feature provides the ability to create and store for global retrieval a complete listing of the user's contacts. A “schedule” feature may offer the ability to create and maintain a complete 24-hour schedule of the users activities including comprehensive connectivity to their PIM, for global retrieval. A user, including a user with only a set-top box or an Internet phone or pager, can send a document to print. The document will go to a print server, and will then be spooled in a data stream over the Internet to the printer designated by the user. Thus, true document printing, as opposed to screen capture, may be provided.

Other features of the operating system include the ability to interface e-mail communications with facsimile, voice and multimedia communications. A preferred feature of the operating system may be to connect all of the applications to each other, which would allow users to access all of the other applications from within a particular application.

The operating system also may have security features, including but not limited to support for digital signatures, encryption, and password protection, as well as a time out feature to prevent access to the user's information if the user has not exited the service or taken any other action for an extended period of time.

The system also may have notification via telephone, facsimile, pager, or other device when e-mail has been received. The system may have additional gateways built to offer the seamless carry over to existing corporate mail and messaging systems such as CCMAIL.

One of many possible ways to implement they system would be to use clustered DEC 64-bit alpha servers (or a server farm) to allow for safe fail-over, distribution of operating load, and scalability. A UNIX operating system could be used. Database programs, such as Berkeley or Oracle databases, and Webserver programs, such as Apache or Netscape Webserver programs, could run on the servers, and the servers could be connected to the Internet through T1 or T3 lines, or other communication channels with wide-band capability.

All patents, patent applications, articles, books and other references cited herein are incorporated herein by reference.

While the invention has been disclosed in connection with the preferred embodiments shown and described in detail, various modifications and improvements will be apparent to one of ordinary skill in the art from the above description, including, for example, continuously updating the customer profile, or updating the customer profile at predetermined intervals or points, such as when a user exits the system.

We claim:

1. A computer operating system for a remote user of a user device capable of sending and receiving signals via a communications network, comprising:
a first server having memory, wherein the first server includes a communications module for sending and receiving signals via the communications network in one or more selected formats from a set of available formats; and
a device recognition module of the first server for determining the type of user device, so that the communications module sends and receives signals in a format selected for the user device.

2. A computer operating system according to claim 1, further comprising:
an application program of the first server that runs in response to signals received from the user device according to the selected communications format.

3. A computer operating system according to claim 1, further comprising a location in the memory of the server for storing information associated with the user of the user device.

4. A computer operating system according to claim 3, wherein the information includes files associated with application programs selected by the user of the user device.

5. A computer operating system according to claim 4, further comprising:
a second server connected to the communications network; and
an application program of the second server, wherein the second server executes the application program of the second server according to a signal from the first server that is formatted by the communications module.

6. A computer operating system, according to claim 1, further comprising:
an access control mechanism of the server for restricting access to a file stored in the memory that is associated with the user of the user device.

7. The computer operating system of claim 1, wherein the user device is selected from the group consisting of: mainframe computers, desktop personal computers, laptop personal computers, network computers, Internet telephones, pagers, cellular phones, mobile phones, satellite phones, hand-held personal information managers, non-computer (NC) appliances, cable television boxes, web televisions, television sets, and set-top boxes.

8. A computer operating system, according to claim 1, wherein the communications network allows communication via wireless transmissions.

9. The computer system of claim 2, wherein the application program of the first server is selected from the group consisting of a web authoring application, an electronic mail application, a database application, a search application, a graphics application, a personal information manager applications, a scheduler application, a calendar application, a word processing application, a spreadsheet application, a calculator application, a document management application, a drawing application, a presentation application, a translation application, a speech recognition module, and a data formatting application.

10. The computer system of claim 5, wherein at least one of the application program of the first server and the application program of the second server is selected from the group consisting of a web authoring application, an electronic mail application, a database application, a search application, a graphics application, a personal information manager applications, a scheduler application, a calendar application, a word processing application, a spreadsheet application, a calculator application, a document management application, a drawing application, a presentation application, a translation application, a speech recognition module, and a data formatting application.

11. A method of providing a computer operating system, comprising:
providing a user device capable of sending and receiving signals via a communications network according to a communications format;
providing a first server having memory, wherein the first server includes a processing mechanism for sending and receiving signals via the communications network according to a selected communications format from a set of available communications formats; determining the communications format for the user device based on characteristics of the signal from the user device;
receiving signals from the user device; and
sending signals to the user device according to the selected communications format.

12. A method of providing a computer operating system according to claim 11, further comprising:
providing an application program of the first server;
running the application program in response to signals received from the user device according to the selected communications format; and
sending signals from the application program to the user device according to the selected communications format.

13. A method of providing a computer operating system according to claim 12, further comprising:
storing information associated with the user of the user device in the memory of the first server.

14. A method of providing a computer operating system according to claim 13, wherein the information includes files associated with application programs selected by the user of the user device.

15. A method of providing a computer operating system according to claim 14, further comprising:
providing a second server connected to the communications network;
providing an application program of the second server;
sending a signal from the first server to the second server according to input from the user device;
running the application program of the second server according to the signal from the first server;
sending a signal corresponding to the results of the application program of the second server to the first server; and
sending the results of the application program of the second server to the user device according to the selected communications format.

16. A method of providing a computer operating system according to claim 15, further comprising:
storing the results of the application program of the second server in the file associated with the user in the memory of the second server.

17. A method of providing a computer operating system, according to claim 11, further comprising:
restricting access by a user to a file stored in the memory that is associated with the user of the user device.

18. The method of providing a computer operating system of claim 11, wherein the user device is selected from the group consisting of: mainframe computers, desktop personal computers, laptop personal computers, network computers, Internet telephones, pagers, cellular phones, mobile phones, satellite phones, hand-held personal information managers, non-computer (NC) appliances, cable television boxes, web televisions, television sets, and set-top boxes.

19. The method of providing a computer operating system of claim 11, wherein the communications network allows communication via wireless transmissions.

20. The method of providing a computer operating system of according to claim 12, wherein the application program of the first server is selected from the group consisting of a web authoring application, an electronic mail application, a database application, a search application, a graphics application, a personal information manager applications, a scheduler application, a calendar application, a word processing application, a spreadsheet application, a calculator application, a document management application, a drawing application, a presentation application, a translation application, a speech recognition module, and a data formatting application.

21. The method of providing a computer operating system of according to claim 12, wherein at least one of the application program of the first server and the application program of the second server is selected from the group consisting of a web authoring application, an electronic mail application, a database application, a search application, a graphics application, a personal information manager applications, a scheduler application, a calendar application, a word processing application, a spreadsheet application, a calculator application, a document management application, a drawing application, a presentation application, a translation application, a speech recognition module, and a data formatting application.

22. A computer operating system that allows a communications device-enabled user to run a plurality of computer applications, independent of the non-communications characteristics of the communications device.

23. The computer operating system of claim 22, wherein, the user may switch between applications.

24. The computer operating system of claim 22, wherein the user may process data between applications.

25. The computer operating system of claim 22, wherein the computer applications are selected from the group consisting of: a web authoring application, an electronic mail application, a database application, a search application, a graphics application, a personal information manager applications, a scheduler application, a calendar application, a word processing application, a spreadsheet application, a calculator application, a document management application, a drawing application, a presentation application, a translation application, a speech recognition module, and a data formatting application.
